(19) United States
(12) Patent Application Publication
(10) Pub. No.: US 2024/0320574 A1
(43) Pub. Date: Sep. 26, 2024

(54) SIGNAL DAMPING AND FILTERING FOR CAPACITY CONTROL AND TRANSACTION MANAGEMENT

(71) Applicant: Home & Local Services, LLC, Eden Prairie, MN (US)

(72) Inventors: Thomas A. JOHNSON, Minnetonka, MN (US); Daniel J. MONDELLO, Minnetonka, MN (US); George M. COFFEE, Plymouth, MN (US); Joseph SKAR, Eden Prairie, MN (US); Katherine R. DONOVAN, Chaska, MN (US)

(21) Appl. No.: 18/187,613

(22) Filed: Mar. 21, 2023

Related U.S. Application Data
(63) Continuation-in-part of application No. 16/666,379, filed on Oct. 28, 2019, now abandoned.
(60) Provisional application No. 62/751,403, filed on Oct. 26, 2018.

(51) Int. Cl. G06Q 10/0631; G06Q 10/1093

(52) U.S. Cl. CPC G06Q 10/06311; G06Q 10/1093

(57) ABSTRACT

An example damping system for capacity signals displays a default present capacity status and projected need signal of the one or more of the service channels based on the corresponding monitored present capacity status and projected need signal. The system displays the calculated connecting parameter of the one or more service channels and automatically generates the notification based on the present capacity status being above the threshold capacity status. The notification can include a present capacity status of one or more services of at least one service channel. The system can automatically update the present capacity status and the connecting parameter of the one or more service channels based on the determination that the present capacity status is above the threshold capacity status. A user may toggle the projected need signal according to the notification to damp the discrepancy between the projected need signal and the future capacity status.

### BACKGROUND

Tracking, damping, and filtering transaction capacity and related data for computing systems can be challenging. Modern computing systems can transmit information among themselves but there are gaps in the ability of these systems to manage a capacity of transactions and allocate resources appropriately based on changes in the capacity. These problems are further compounded by increased complexity when coordinating these transactions across multiple user interfaces and computing systems.

### BRIEF DESCRIPTION OF THE DRAWINGS

Reference will now be made to the accompanying drawings, which illustrate exemplary embodiments of the present disclosure. In the drawings:

FIG. 1A is a block diagram of an exemplary capacity management system, according to some embodiments.

FIG. 1B is a block diagram of an exemplary signal filtering system, according to some embodiments.

FIG. 1C is a block diagram of an exemplary signal damping system, according to some embodiments.

FIG. 1D is a block diagram of an exemplary user prediction system, according to some embodiments.

FIG. 2 is a block diagram of an exemplary capacity management, according to some embodiments.

FIG. 3 shows an aspect of an example client interface, according to some embodiments.

FIG. 4 shows an aspect of an example transaction dashboard interface, according to some embodiments.

FIG. 5 shows an aspect of an example transaction data interface, according to some embodiments.

FIG. 6 shows an aspect of an example authorized users interface, according to some embodiments.

FIG. 7A shows an aspect of an example transaction verification interface, according to some embodiments.

FIG. 7B shows an aspect of an example transaction verification interface, according to some embodiments.

FIG. 7C shows an aspect of an example transaction verification interface, according to some embodiments.

FIG. 8A shows an aspect of an example interaction report interface, according to some embodiments.

FIG. 8B shows an aspect of an example interaction report interface, according to some embodiments.

FIG. 8C shows an aspect of an example interaction report interface, according to some embodiments.

FIG. 8D shows an aspect of an example interaction report interface, according to some embodiments.

FIG. 8E shows an aspect of an example interaction report interface, according to some embodiments.

FIG. 8F shows an aspect of an example interaction report interface, according to some embodiments.

FIG. 9 shows an aspect of an example notifications interface, according to some embodiments.

FIG. 10A shows an example method, according to some embodiments.

FIG. 10B shows another example method, according to some embodiments.

FIG. 10C shows another example method, according to some embodiments.

FIG. 10D shows another example method, according to some embodiments.

FIG. 10E shows another example method, according to some embodiments.

FIG. 11 is a block diagram that illustrates a computer system upon which various embodiments may be implemented.

### DESCRIPTION OF EXEMPLARY EMBODIMENTS

Reference will now be made in detail to several exemplary embodiments of the present disclosure, including those illustrated in the accompanying drawings. Whenever possible, the same reference numbers will be used throughout the drawings to refer to the same or like parts.

According to some embodiments, the operations, techniques, and/or components described herein can be implemented by an electronic device, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that incorporates hard-wired and/or program logic to implement the techniques and other features of the present disclosure.

The one or more special-purpose computing devices can be generally controlled and coordinated by operating system software, such as IOS, Android, Blackberry, Chrome OS, Windows XP, Windows Vista, Windows 7, Windows 8, Windows Server, Windows CE, Unix, Linux, SunOS, Solaris, VxWorks, or other compatible operating systems. In other embodiments, the computing device can be controlled by a proprietary operating system. Conventional operating systems control and schedule computer processes for execution, perform memory management, provide file system, networking, I/O services, and provide a user interface functionality, such as a graphical user interface (“GUI”), among other things.

A capacity management system, signal filtering system, and/or signal damping system can solve many of the problems and shortcomings of modern computing systems described above. For example, capacity management systems described herein may be able, for example, to differentiate image data for a transaction data associated with a higher capacity from other image data for different transaction data. This differentiation can be provided at a client interface or at a user interface, or both. The differentiation can streamline data flow to the right location, at the right time, and for the right circumstances. In a world with fast-paced changes to information and circumstances surrounding that information, incorrect, deceiving, or even just stale data can often bog down systems and prevent the proper flow of information through the proper channels and to the right destinations. Such systems can be useful wherever significant amount of information requires regular updates based on real-time changes in capacity of available transactions. These circumstances may arise, for example, in a software engineering context, data analytics, client- or customer-facing graphical user interfaces, marketing demands, and many other contexts. Although reference may be made herein to one or more particular contexts and/or embodiments, it should be appreciated that these embodiments are not restricted to these contexts and may be used appropriately to solve other transaction capacity needs.

One aspect of many systems described herein is an ability to receive one or more transaction capacity thresholds. These transaction capacity thresholds can correspond to respective transaction details. For example, goods and services may be offered at an attractive (e.g., lower) price when inventory or availability is relatively high but may be offered at a more restrictive (e.g., higher) price when the inventory or availability is low. For example, a plumbing service provider may offer a certain price or offer when plumbing service capacity is above a certain first capacity (e.g., above 80% max availability), a second price or offer when the plumbing service capacity is above a second capacity (e.g., above 50% max availability) but below the first capacity.

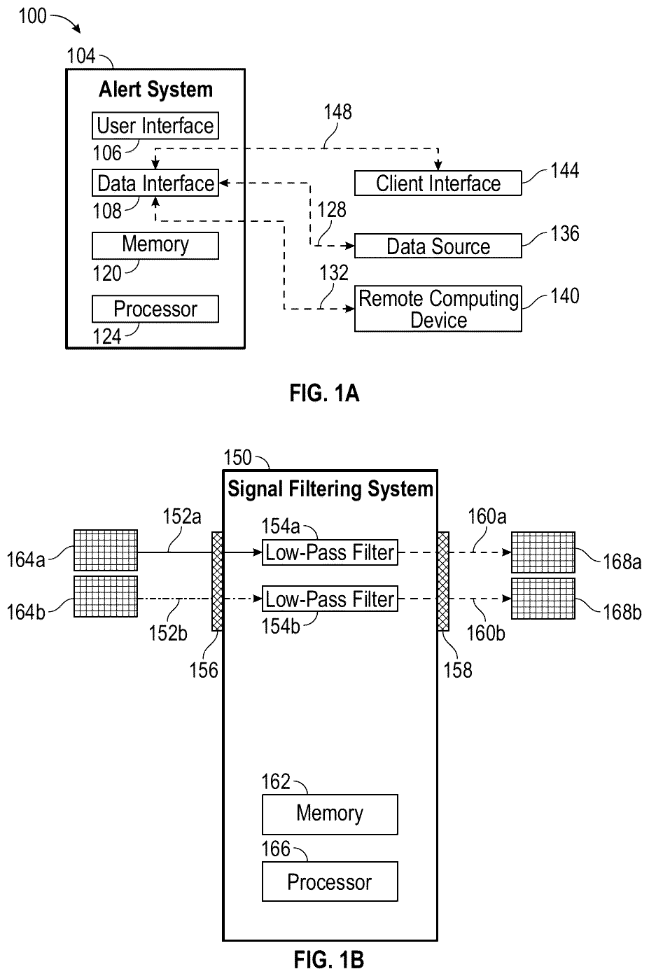

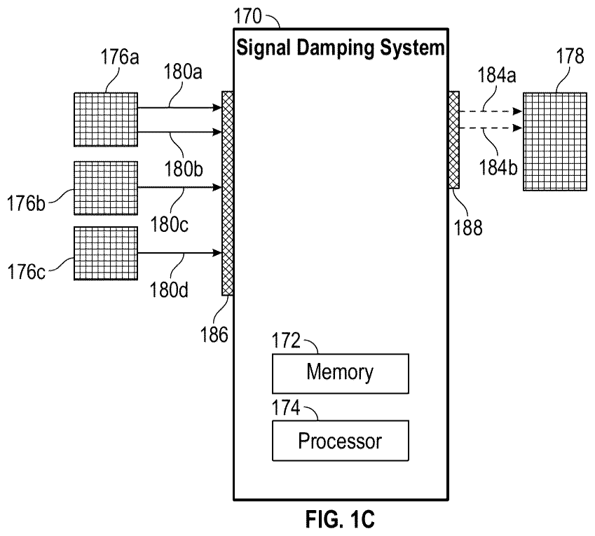

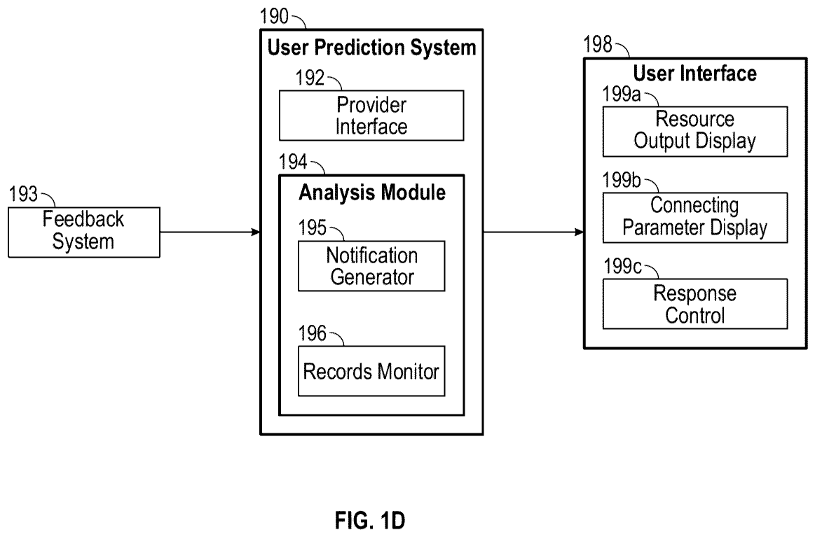

FIG. 1A shows an example capacity management system 100 for generating image data to display first transaction data, updating the image data to display second transaction data, and to transmit an alert to a destination computing device, such as a remote computing device 140. The alert may include the second transaction data and an indication of a current transaction capacity. In some embodiments, the alert is generated on a user interface described herein, such as on a notifications interface 900 described below. Information for such a user interface may be stored at a remote computing device, such as the remote computing device 140.

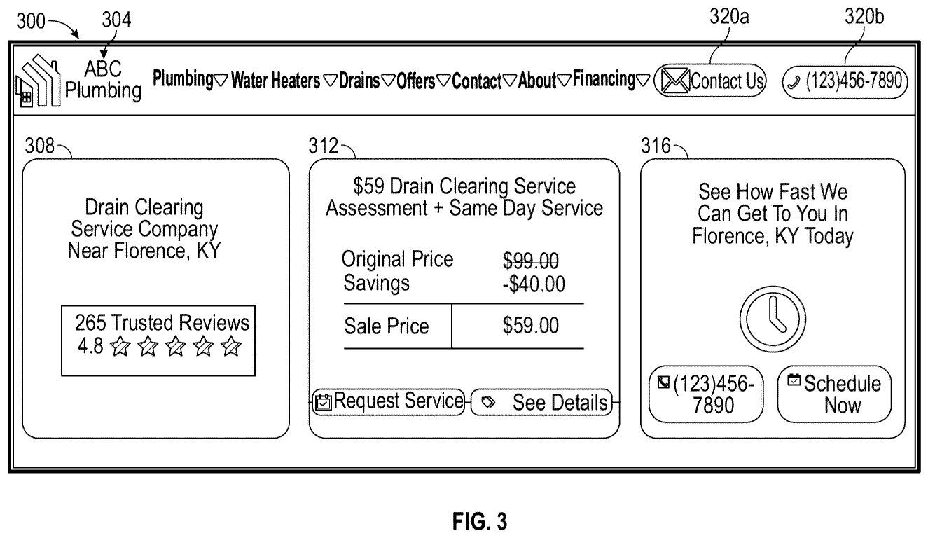

The capacity management system 100 can include an alert system 104, a data interface 108, a memory 120, a processor 124, a client interface 144, a data source 136, and/or a remote computing device 140. The alert system 104 may configured to generate and transmit an alert to the remote computing device 140. The alert system 104 may be configured to determine whether a threshold transaction capacity has been met or exceeded. The alert system 104 may interface with one or more client interfaces 144, one or more data sources 136, and/or one or more remote computing devices 140. An example client interface 144 is shown and described in FIG. 3. In some embodiments, the remote computing device 140 sends a request for data from the alert system 104. For example, the alert system 104 may receive, from the remote computing device 140, a request for a current transaction capacity and/or for current transaction data. In some embodiments, the remote computing device 140 is a destination computing device.

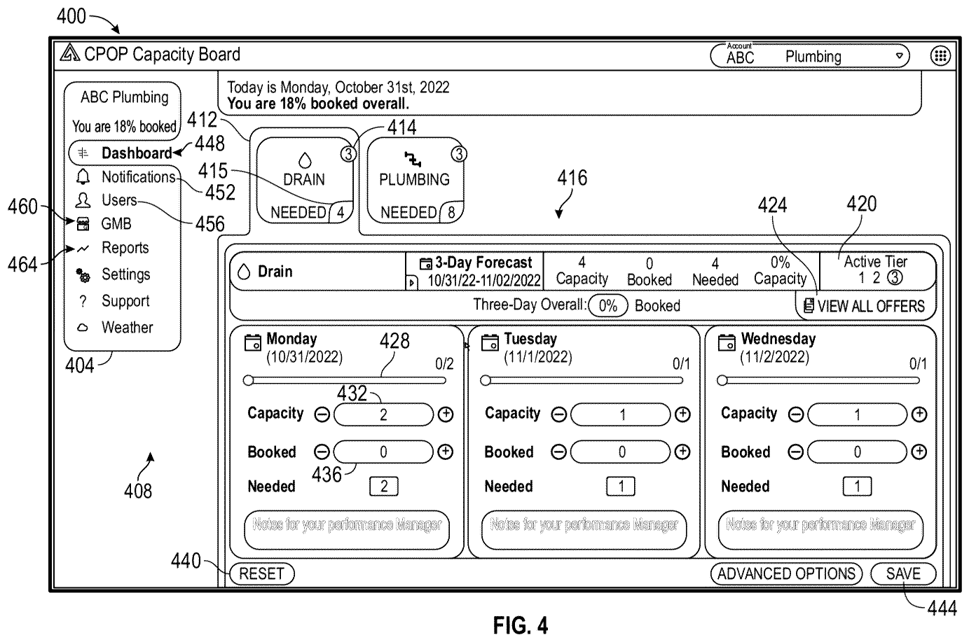

The user interface 106 can be configured to receive user input and/or provide output to a user. Example user interfaces are described herein, such as with respect to FIGS. 4-9. The user interface 106 can be implemented via an electronic device that includes a display and one or more buttons, switches, dials, capacitive touch interfaces, or touchscreen interfaces. In certain embodiments, at least a portion of the user interface is implemented via an electronic device separate from the message transportation management system 100. In some embodiments, the user interface 106 includes a computer display and/or a display of a mobile device (e.g., smartphone).

The data interface 108 may be in communication (e.g., wired, wireless) with one or more of a data source 136 and/or a remote computing device 140. For example, the data interface 108 may be configured to receive data related to available and/or booked transactions from the data source 136. The data may include descriptors of the transactions. The descriptors may be related to one or more of transaction time(s), a transaction duration, a transaction cost, a special offer associated with the transaction (e.g., a free plumbing system included), contact details for a service provider, and/or a location for where services associated with the transaction are to take place. The data interface 108 may communicate with the data source 136 via a data connection 128, which may be wired and/or wireless.

The data interface 108 may be in communication with the remote computing device 140, such as a user device, a remote server, a remote database, etc. The data interface 108 may communicate with the remote computing device 140 via a data connection 132, which may be wired and/or wireless. Example user devices include a desktop computer, a laptop, and a mobile phone, each provided by way of illustration only. In general, a user devices can be any computing device such as a desktop, laptop or tablet computer, personal computer, tablet computer, wearable computer, server, personal digital assistant (PDA), PDM, hybrid PDA/mobile phone, mobile phone, smartphone, set top box, voice command device, digital media player, and the like. A user device may execute an application (e.g., a browser, a stand-alone application) that allows a user to access and interact with interactive graphical user interfaces as described herein. The user device may be configured to display the image data described below.

In some embodiments, the remote computing device 140 can include a network. The network may be a personal area network, local area network, wide area network, over-the-air broadcast network (e.g., for radio or television), cable network, satellite network, cellular telephone network, or combination thereof. As a further example, the network may be a publicly accessible network of linked networks, possibly operated by various distinct parties, such as the Internet. In some implementations, the network may be a private or semi-private network, such as a corporate or university intranet. The network may include one or more wireless networks, such as a Global System for Mobile Communications (GSM) network, a Code Division Multiple Access (CDMA) network, a Long Term Evolution (LTE) network, or any other type of wireless network. The network can use protocols and components for communicating via the Internet or any of the other aforementioned types of networks. For example, the protocols used by the network may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein. The network may comprise the “cloud.” The network may include a remote computing environment.

The memory 120 can be any type of main memory that can communicate instructions to the processor 124 and receive executed instructions from the processor 124. Types of memory 120 include but are not limited to random access memory (“RAM”) and read only memory (“ROM”). Other embodiments may be envisioned that incorporate other types of memory 120 in the capacity management system 100.

The memory 120 can be any type of computer storage that can receive data, store data, and transmit data to other elements of the capacity management system 100 (e.g., via a bus). Types of storage that can be used in the memory 120 include, but are not limited to, magnetic disk memory, optical disk memory, and flash memory.

The client interface 144 can be any computing device where another user may be able to access (and/or in some embodiments modify) transaction data stored in the memory 120 of the alert system 104. A user may be able to update the client interface 144 to suit the needs or goals of the user. The client interface 144 can allow other users to book or reserve transactions (e.g., services), to learn more about available transactions, and/or to contact the alert system 104. As shown, the client interface 144 is in operative communication with the data interface 108 via a data connection 148. Additional details about an example client interface 144 are shown in FIG. 3.

The alert system 104 can receive bookings of transactions (e.g., services). The bookings can be received from the client interface 144 via the data connection 148. Additionally or alternatively, the bookings may be received from a destination computing device, such as the remote computing device 140. In some embodiments, the remote computing device 140 and the client interface 144 may be controlled by or be the same computing system.

FIG. 1B is a block diagram of an exemplary signal filtering system 150, according to some embodiments. The signal filtering system 150 can include a user interface 156, a data interface 158, one or more low-pass filters 154a, 154b, memory 162, and/or a processor 166.

The user interface 156 can receive information from a user, as may be the case with other user interfaces described herein. The user interface 156 can receive one or more inputs from a user. The inputs may include a first capacity signal 152a corresponding to a first channel. The inputs may additionally or alternatively include a second capacity signal 152b, which may correspond to a second channel of the signal filtering system 150. Each of the capacity signals 152a. 152b may correspond to a number of available slots for a service or transaction, as described elsewhere herein. Each of the channels may be operated independently of each other. However, in some embodiments, the channels may be operated together such that the capacity signals 152a, 152b may be combined in some way (e.g., added together, subtracted from one another). Each channel may represent or correspond to a separate service provided by a service provider. For example, a first channel may correspond to a drain cleaning service while a second channel may correspond to a toilet repair service. Other options are possible. The signal filtering system 150 can manage one, two, three, or more channels simultaneously.

The user interface 156 may receive the capacity signals 152a, 152b via one or more client computing devices 164a, 164b, in some embodiments, the capacity signals 152a, 152b may additionally or alternatively be received via a data interface (e.g., the data interface 158, another data interface). The first client computing device 164a can generate the first capacity signal 152a and the second client computing device 164b can generate the second capacity signal 152b. The client computing devices 164a. 164b may be different computing devices or the same computing device. It may be that one of the capacity signals 152a, 152b is greater/lower than a target capacity availability and/or greater/lower than a threshold capacity. The signal filtering system 150 may receive the capacity signals 152a, 152b and determine whether one or more of the capacity signals 152a, 152b is greater or lower than a respective threshold capacity. The signal filtering system 150 may use the respective low-pass filter 154a, 154b to determine whether additional measures need to be taken, such as modifying an output from the signal filtering system 150. The low-pass filters 154a, 154b may include corresponding capacity thresholds, as described herein.

The outputs of the signal filtering system 150 may include one or more trigger parameters 160a, 160b. Each of the trigger parameters 160a. 160b may be output to one or more remote computing devices 168a, 168b via the data interface 158. The remote computing devices 168a, 168b may be different computing devices or the same computing device.

A user of the signal filtering system 150 may set the capacity thresholds of the low-pass filters 154a, 154b and/or they may be automatically calculated. For example, they may be automatically calculated based on previous output from the signal filtering system 150 (e.g., the trigger parameters 160a, 160b).

The processor 166 can execute instructions to perform a number of actions. For example, the processor 166 can generate data for displaying default trigger parameters (e.g., prices for services) and default projected need signals (e.g., resources spent on a marketing) for each of the first and second service channels 154a, 154b. The signal filtering system 150 can receive, via the user interface 156, for each of first and second service channels, a corresponding low-pass filter 154a, 154b. The low-pass filters 154a, 154b may include corresponding threshold capacities. The signal filtering system 150 can receive one or more default trigger parameters that is larger (e.g. stronger signal) than the default trigger parameter. Additionally or alternatively, the signal filtering system 150 may receive one or more default projected need signals that are or smaller (weaker signal) than the default projected need signals.

The signal filtering system 150 may periodically receive, from one or more electronic devices (e.g., the client computing devices 164a, 164b, the remote computing devices 168a, 168b) via the data interface 158, updated capacity signals (e.g., the capacity signals 152a, 152b) for each of the first and second service channels.

The signal filtering system 150 can determine that a received capacity signal for the first channel is below the first threshold capacity (e.g., of the first low-pass filter 154a) for the first channel. Additionally or alternatively, the signal filtering system 150 can determine that a received capacity signal for the first channel is above the first threshold capacity for the first channel. Additionally or alternatively, the signal filtering system 150 can determine that a received capacity signal for the second channel is not below the first threshold capacity for the second channel.

Using the low-pass filters 154a, 154b, the signal filtering system 150 can generate updated data for displaying the updated first trigger parameter for the first channel (since it exceeds the threshold) but not for the second channel (since it does not exceed the threshold) based on a determination that the received capacity signal for the first channel is below the first threshold capacity for the first channel and that the received capacity signal for the second channel is not below the first threshold capacity for the second channel.

The signal filtering system 150 may automatically generate a notification based on the determination that the received capacity signal for the first channel is below the first threshold capacity for the first channel. The notification may include one or more features of the notification and/or alerts described herein. For example, the notification comprising a display of the first projected need signal.

FIG. 1C is a block diagram of an exemplary signal damping system 170, according to some embodiments. The signal damping system 170 can include a memory 172, a processor 174, a user interface 186, and/or a data interface 188. The user interface 186 may include one or more features any of the user interfaces described herein, and the data interface 188 may include one or more features of the other data interfaces described herein.

The user interface 186 can be configured to receive one or more signals 180a, 180b, 180c, 180d. The signals 180a, 180b, 180c, 180d can include a projected need signal 180a, a connecting parameter 180b, a present capacity status 180c, and/or a target capacity status 180d. One or more of the signals 180a, 180b, 180c, 180d may come from corresponding client computing devices 176a, 176b, 176c. Additionally or alternatively, one or more of the signals 180a, 180b, 180c. 180d may come from the same first client computing device 176a, 176b, 176c. The client computing devices 176a, 176b, 176c may include one or more features of the other client computing devices described herein (e.g., the client interface 144, the client computing devices 164a, 164b, etc.).

The projected need signal 180a can include an expected or predicted need. For example, the projected need may correspond to an amount of resources (e.g., money) directed toward marketing efforts or an amount of resources required to otherwise reduce a future capacity toward a target (e.g., lower) capacity. The connecting parameter 180b can correspond to any factor that may connect the projected need signal 180a to an amount of capacity, such as the present capacity status 180c and/or the target capacity status 180d. For example, the connecting parameter 180b may include a price, a rebate, a special offer, a trade-in, etc. As the connecting parameter 180b rises, the projected need signal 180a may similarly increase in some instances, such as when the need signal needs to be maintained at a higher rate. In some configurations, the connecting parameter 180b may rise when the projected need signal 180a drops (or vice versa). This may correspond to a determination by the signal damping system 170 that an available capacity is more heavily influenced by one of the projected need signal 180a and connecting parameter 180b than by both approximately equally.

A user may set one or more of the signals 180a, 180b, 180c, 180d, such as via the user interface 186. Additionally or alternatively, one or more of the signals 180a, 180b, 180c, 180d may be set automatically, such as based on a previously set value for one or more of the signals 180a, 180b, 180c, 180d. The signal damping system 170 can calculate receive the signals 180a, 180b. 180c, 180d and determine resulting updated signals 184a, 184b to output. For example, the updated need signal 184a may be reduced if the present capacity status 180c is lower than a threshold capacity. Additionally or alternatively, the updated need signal 184a may be increased if the present capacity status 180c is higher than a threshold capacity.

In some embodiments, the updated need signal 184a may be based on a combination of the present capacity status 180c and the target capacity status 180d. For example, the updated need signal 184a may be increased relative to the projected need signal 180a if a difference between the present capacity status 180c and the target capacity status 180d is greater than a capacity threshold. Additionally or alternatively, the updated need signal 184a may be decreased relative to the projected need signal 180a if a difference between the present capacity status 180c and the target capacity status 180d is lower than a capacity threshold. The capacity threshold may be defined as a percentage of total capacity and/or an absolute amount of capacity.

FIG. 1D shows an example user prediction system, according to some embodiments. The user prediction system 190 may be coupled to and/or include a feedback system 193 and/or a user interface 198. The user prediction system 190 can include a provider interface 192 and/or a analysis module 194. The analysis module 194 may include a notification generator 195 and/or a records monitor 196. The provider interface 192 can include one or more features of a client interface described herein, such as the client interface 144. The provider interface 192 can include a capacity input control, a resource output control, and/or a connecting parameter control. The capacity input control can include water in a reservoir, power that is generated by solar panels and stored in a battery, or some other capacity. The resource output control can include a number of recipients providing information about capacity to third parties, it can include an amount of information that was broadcast publicly about an availability of a resource, and/or it can include a digital marketing budget for reaching third parties. The connecting parameter can be one or more of credits, coupons, price, and/or an offer for obtaining water, electricity, services provided by workers, or some other resource. The provider interface 192 can be configured to display a control signal. The control signal may include a confirmation of the change in water capacity, an indication of service appointments booked, and/or a modification of a connecting parameter.

The analysis module 194 can determine a future capacity prediction by calculating a combination of a recent history of resource output and a connecting parameter. The recent history of resource output may include a record of one or more instances when resources were deployed in connection with a corresponding connecting parameter (which may change based on the resource output and/or which may cause the connecting parameter to be modified). The combination may be modified by efficiency and delay functions. An efficiency function may include a conversion of how much resource was output compared to how much resource actually translated into functional benefit (e.g., how much information was supposed to be broadcast about the available capacity compared to how much was actually broadcast, or how much marketing spend was translated to actual advertisement). A delay function can include a calculation of a lag time between when the instruction to apply the resource output was given compared to when the information was actually broadcast or a delay between the marketing budget was allocated for advertisements and when the advertisements actually went live. There are many other applications of these features.

The analysis module 194 can algorithmically combine a past input and a present input based on the determination of the future capacity prediction. For example, the past input and the present input may correspond to past and present inputs of any input described herein, such as a past amount of capacity booking and a present amount of capacity booking. Based on the past and present inputs, the analysis module 194 can determine whether capacity is presently available or if present capacity has been exhausted. If present capacity has been exhausted, then the analysis module 194 can calculate a carryover amount of needed capacity that may need to be applied to a future available capacity. The analysis module 194 may compare a sum of the future capacity prediction and the carryover to a notification threshold. The notification threshold may be any notification capacity threshold described herein. If the analysis module 194 determines that the sum exceeds the notification threshold, it may generate a notification to manually or automatically adjust one or more of the resource output controls or the connecting parameter controls. For example, if the sum exceeds the notification threshold, the analysis module 194 may instruct a reduction in the resource output and/or a reduction in the connecting parameter. In this way, the system can help predict a future user response and, in real-time, damp and/or filter future signal output to better ensure that the future capacity is closer to a target future capacity (which may be set automatically and/or set or adjusted by a user). For example, the analysis module 194 can damp fluctuations in future provider capacity by using the efficiency and/or delay functions to predict user use of response control and preempting changes by notifying user to reduce resource output control and increase connecting parameter control. The analysis module 194 may cause a control signal (e.g., an indication of the changes made, or some other control signal described herein) to be displayed by the provider interface 192.

In some embodiments, the user prediction system 190 includes a user interface 198. The user interface 198 can include a resource output display 199a, a connecting parameter display 199b, and/or a response control 199c. The resource output display 199a can be configured to promptly respond to control signals from the analysis module 194 such that the user interface 198 changes output to users in real time in response to updates from a provider (e.g., supplier, service provider). The connecting parameter display 199b can be configured to promptly respond to control signals from the analysis module 194 such that the user interface 198 changes output to users in real time in response to updates from a provider. The response control 199c can be configured to change future provider capacity based on present connecting parameter value. The user prediction system 190 can include one or more features of any user interface described herein, such as the user interface 106.

The feedback system 193 can include determine an effectiveness of the analysis module 194 in determining the future capacity prediction. This may include determining whether a history of sums comprising the sum includes a number of times alerts were generated and/or determining whether the number of times alerts were generated exceeds a satisfaction threshold. The satisfaction threshold may include a whole number, such as 1, 2, 3, or more. If the number of times alerts were generated is below that threshold, then the feedback system 193 can cause the analysis module 194 to reduce or increase the future capacity prediction in a future calculation (e.g., relative to what would have otherwise been calculated). The analysis module 194 may be configured to automatically increase the connecting parameter when the sum of the future capacity prediction and the carryover exceeds the notification threshold.

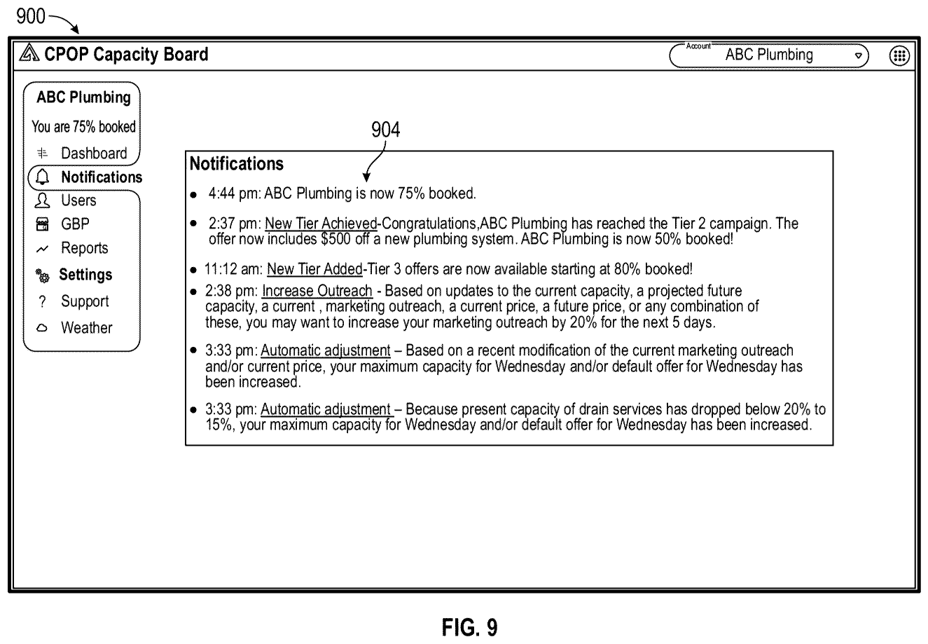

The notification generator 195 can accept input from the capacity input control, resource output control, and/or connecting parameter control of the provider interface 192 and generate a notification in response to a threshold described herein being exceeded. The notifications generated by the notification generator 195 can include one or more features of notifications described herein (e.g., as shown in FIG. 9). Additionally or alternatively, the notification may include at least one paired suggestion for size of incremental change to both resource output and connecting parameter. The suggestion may be based on feedback from previous use.

The records monitor 196 can store a record of the input accepted by the notification generator 195. The records monitor 196 can store a relationship between the resource output (e.g., from the resource output control) and the connecting parameter (e.g., from the connecting parameter control). In some embodiments, the relationship comprises a step function such that the relationship corresponds to different levels of connecting parameter and/or resource output to achieve local minima of future capacity.

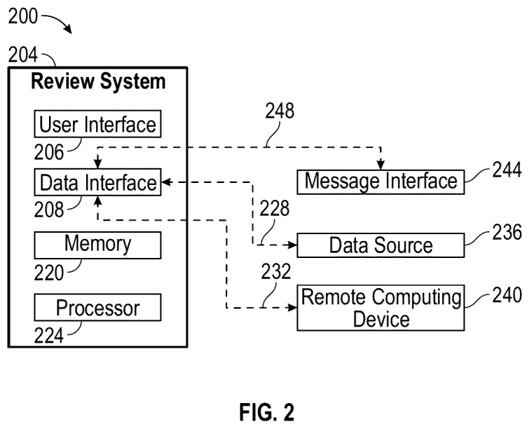

FIG. 2 shows another example capacity management system 200, according to some embodiments. The capacity management system 200 can include a review system 204, a message interface 244, a data source 236, and/or a remote computing device 240. The user interface 206 may include one or more features of the user interface 106. The data interface 208 may include one or more features of the data interface 108. The memory 220 may include one or more features of the memory 120. The processor 224 may include one or more features of the processor 124.

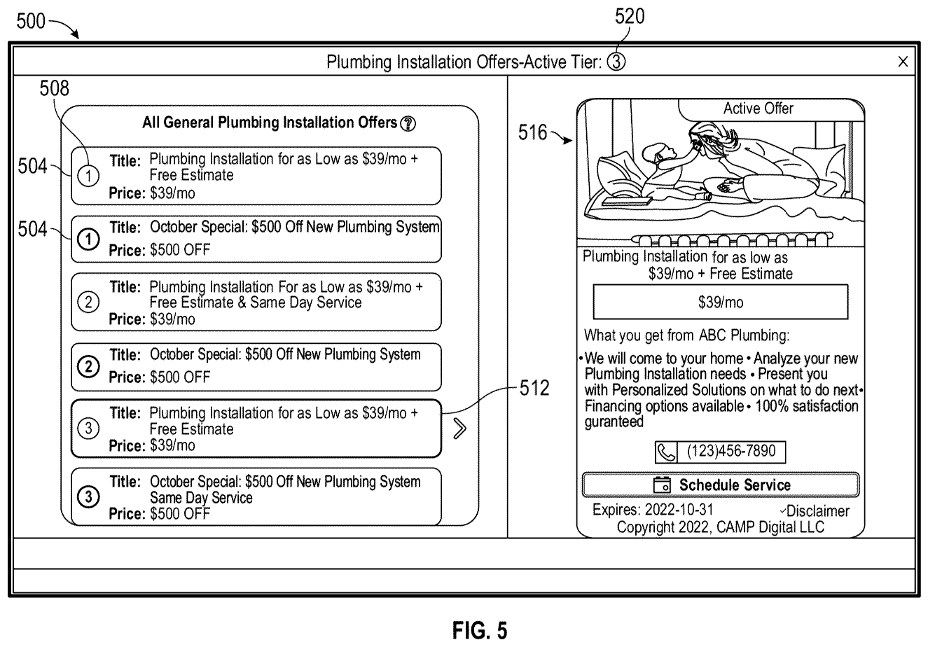

The review system 204 can be configured to generate image data for displaying transaction data that was previously shown. The review system 204 can allow a user to review, for example, older transactional data that may no longer be available based on capacity data. For example, a user may see that certain plumbing services are available at a low price and then later notice that the same low price is no longer available (e.g., possibly because capacity for plumbing services has dropped since seeing the low price). The review system 204 may be able to identify the time identified by the user and confirm that the low price was originally offered to the user at that time. For example, the review system 204 may receive a timestamp from the message interface 244 indicating when the user is referring to. Additionally or alternatively, the message interface 244 may receive a timestamp of the time the user initiated the phone call and automatically determine that the low price was available at the time of the phone call. This may allow a user of the user interface 206 to identify an appropriate price for the caller. Additional examples and details are provided below, such as with regard to FIG. 5.

FIG. 3 shows an example client interface 300, according to some embodiments. The client interface 300 may correspond to and/or include one or more features of the client interface 144 of FIG. 1. The client interface 300 can include a transaction servicer indicator 304, a transaction servicer descriptor 308, transaction data 312, a transaction selector 316, and/or one or more servicer messaging selectors 320a, 320b.

The transaction servicer indicator 304 can provide information regarding an entity that is providing the requested services. For example, the transaction servicer indicator 304 may show ABC Plumbing as the service provider for plumbing services. The client interface 300 can be owned and/or operated by users associated with the service provider shown by the transaction servicer indicator 304 (e.g., ABC Plumbing in this case).

The transaction servicer descriptor 308 can provide a user information about what the service provider does and why it may be useful. The transaction servicer descriptor 308 may describe an overview of what the services offered are or could be. The transaction servicer descriptor 308 may additionally or alternatively include an indicator of trust, such as a number and/or aggregate value (e.g., mean) of user reviews of the servicer. For example, as shown the transaction servicer descriptor 308 indicates that the servicer has 265 trusted reviews with an aggregate score of 4.8 stars out of 5.

The transaction selector 316 can allow a user (e.g., a potential customer) to schedule an appointment via the client interface 300. Such scheduling may reduce an available transaction capacity, as described herein. Additionally or alternatively a user may sect the transaction selector 316 to contact the service provider. When scheduling the service, a user may select a time, a location, an amount of requested services, and/or other detail related to the requested services. The servicer messaging selectors 320a, 320b can allow a user to directly contact the servicer, such as by email, SMS message (e.g., text), and/or by calling. The client interface 300 can include additional details about the service provider, the transaction details, contact information, and/or how to pay for the services.

FIG. 4 shows an example transaction dashboard interface 400, according to some embodiments. The transaction dashboard interface 400 may be included as part of a user interface described herein, such as the user interface 106 and/or user interface 206. The transaction dashboard interface 400 can include a transaction servicer indicator 404, a selector interface 408, and/or a transaction capacity interface 416. The selector interface 408 can include a transaction dashboard interface selector 448, a notifications interface selector 452, an authorized users interface selector 456, a transaction verification interface selector 460, and/or an interaction report interface selector 464.

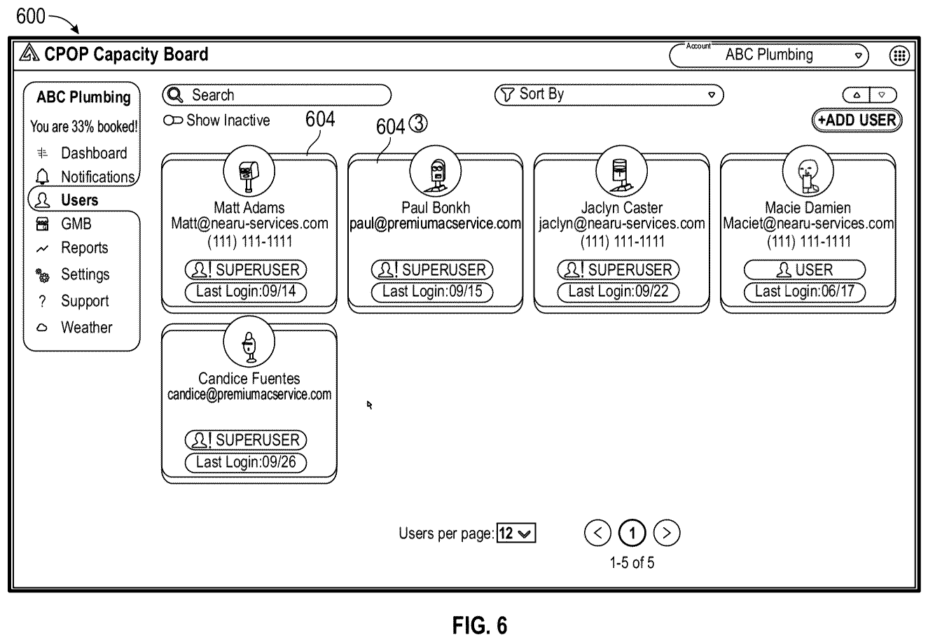

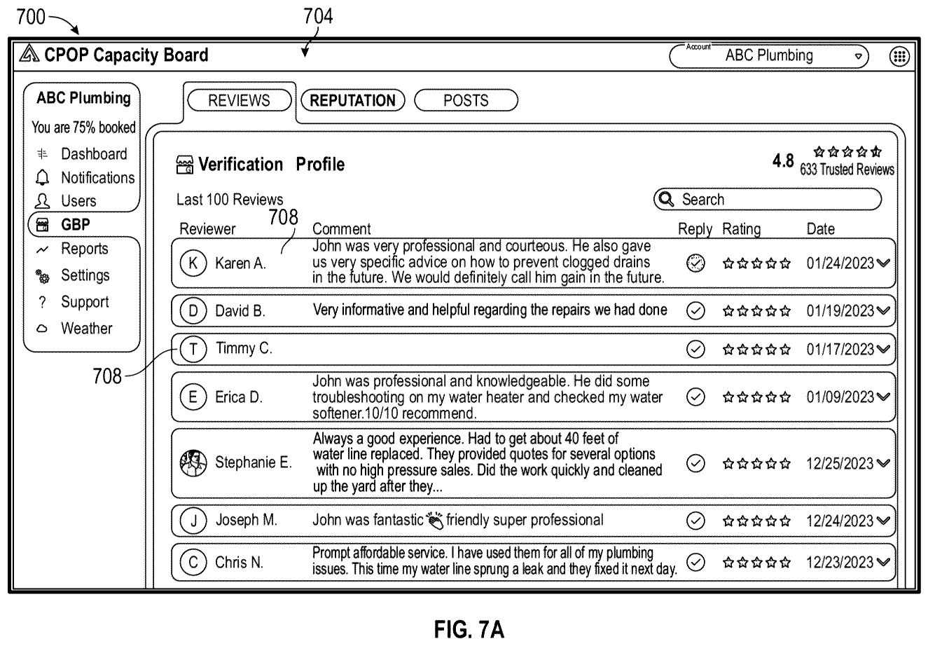

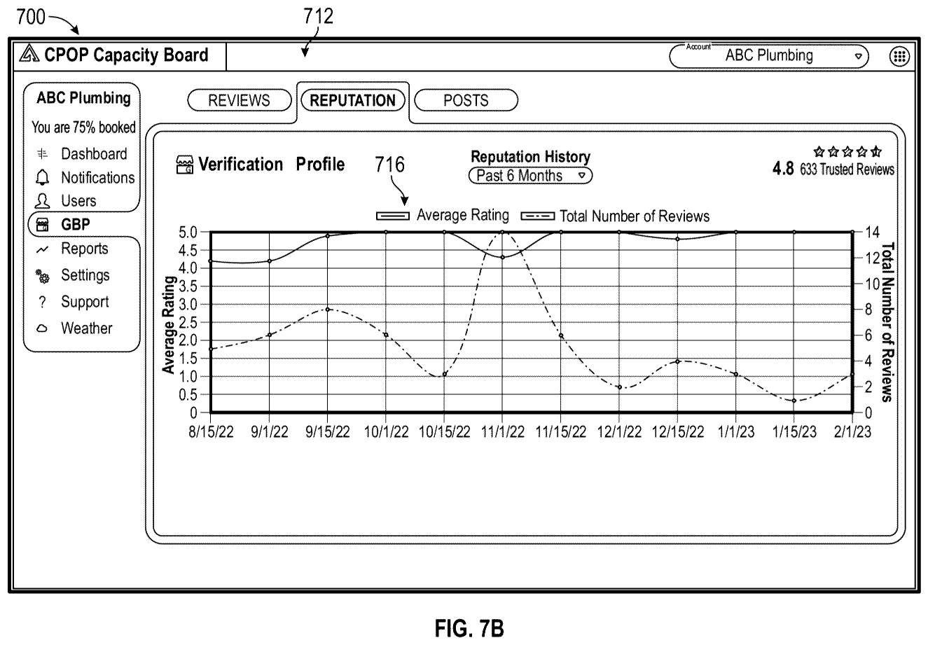

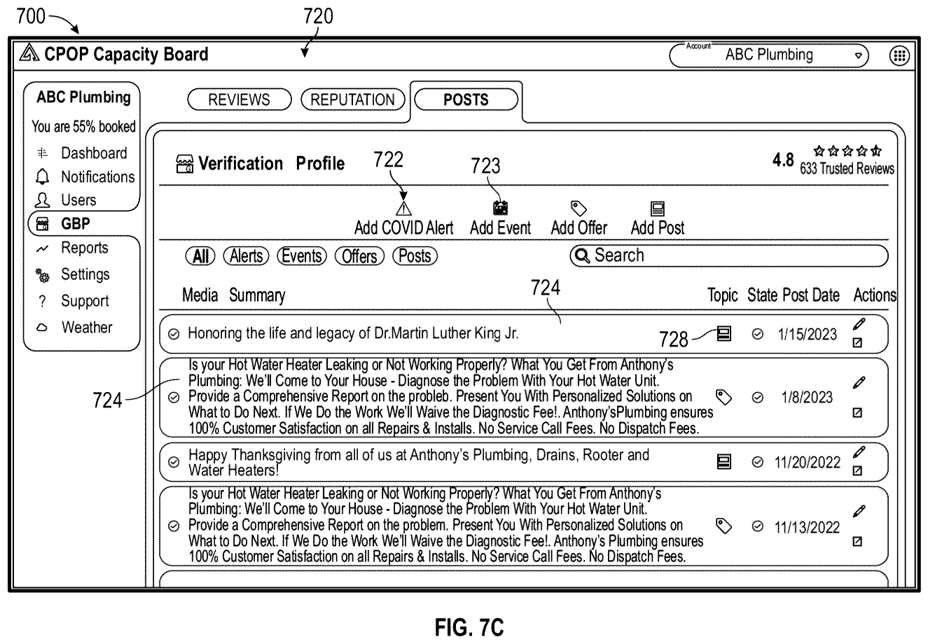

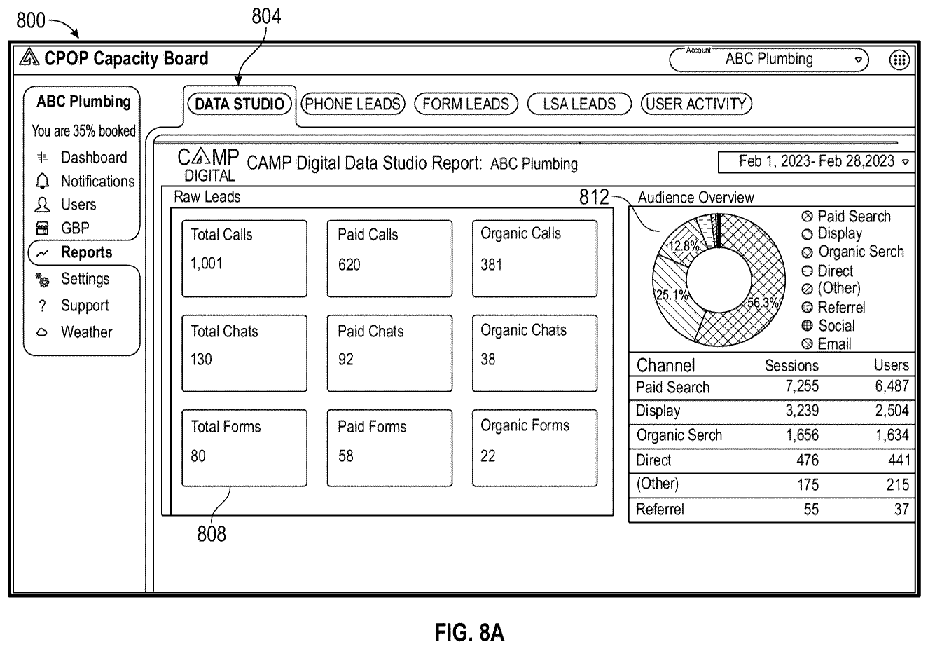

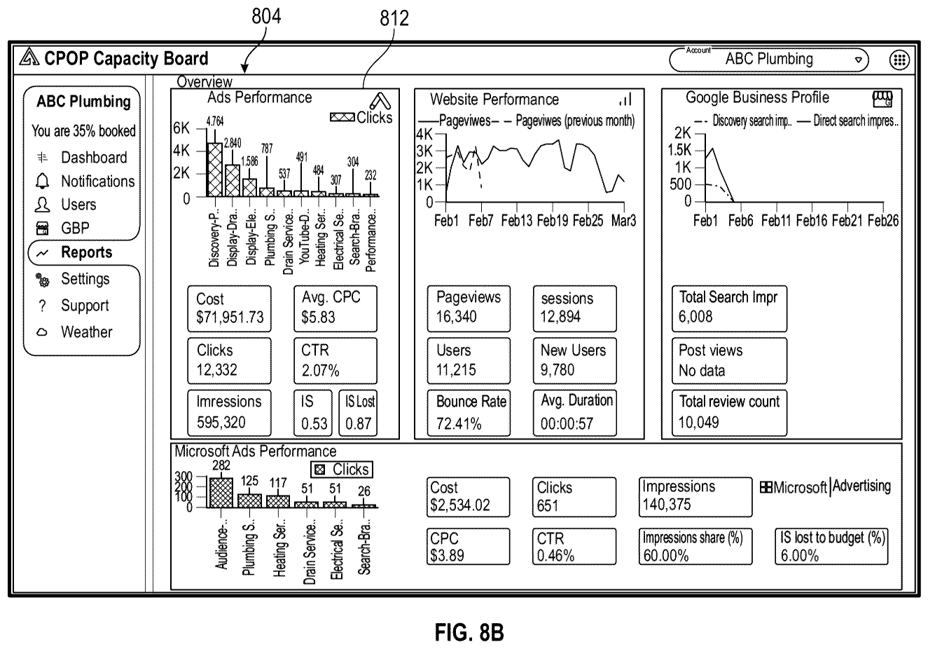

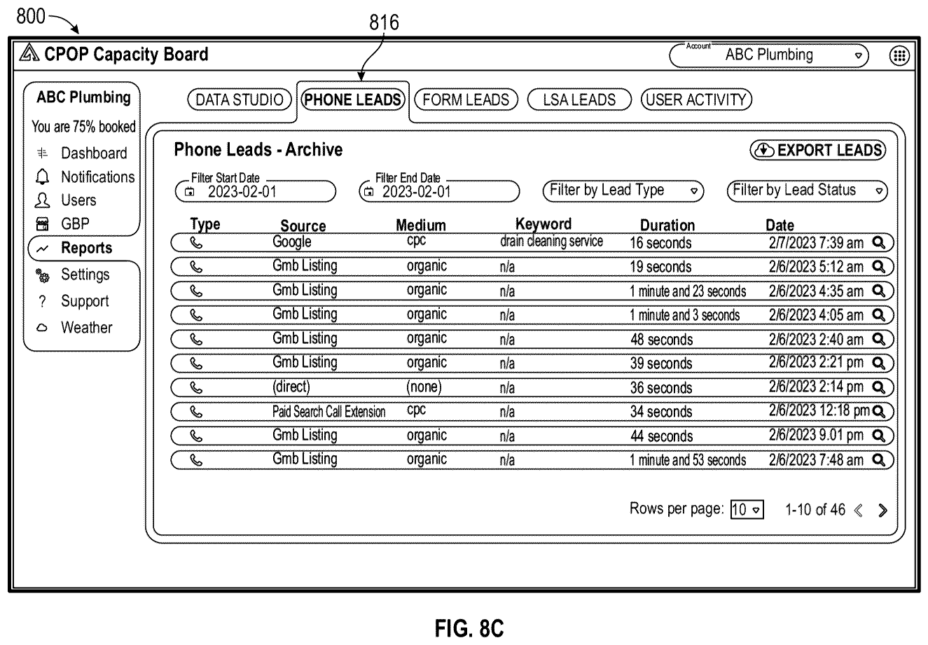

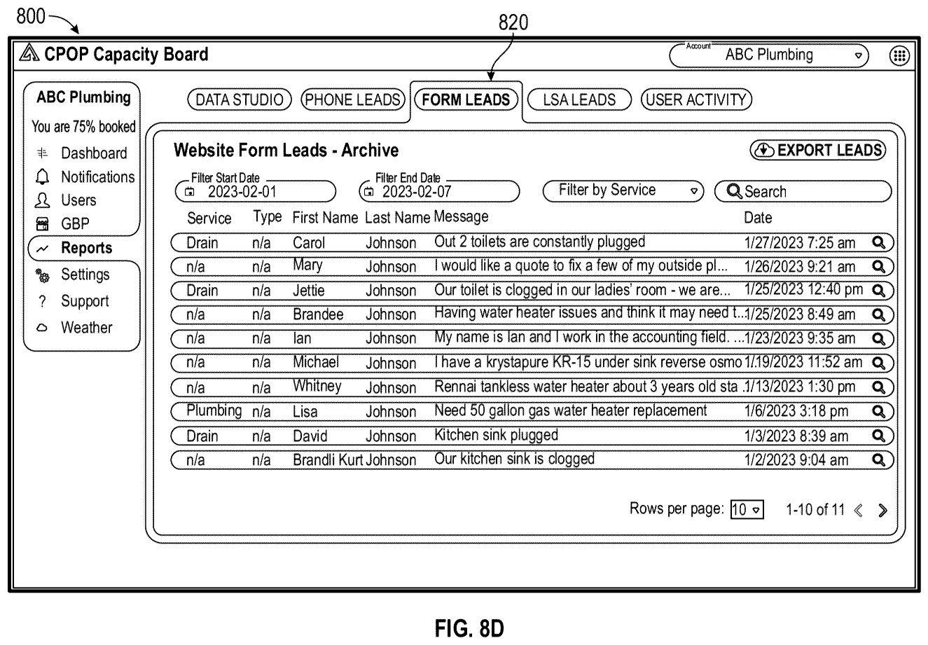

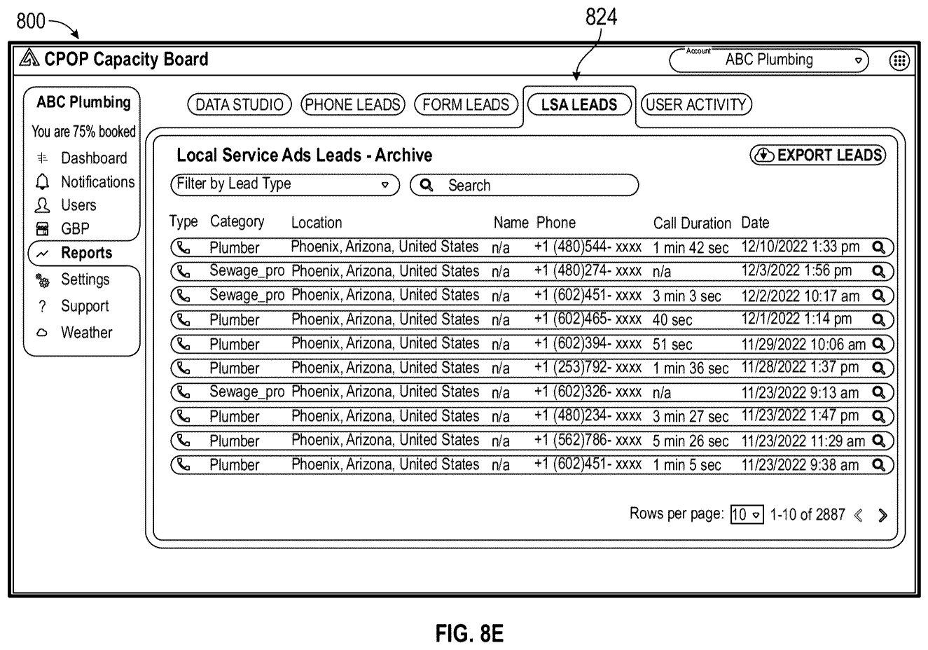

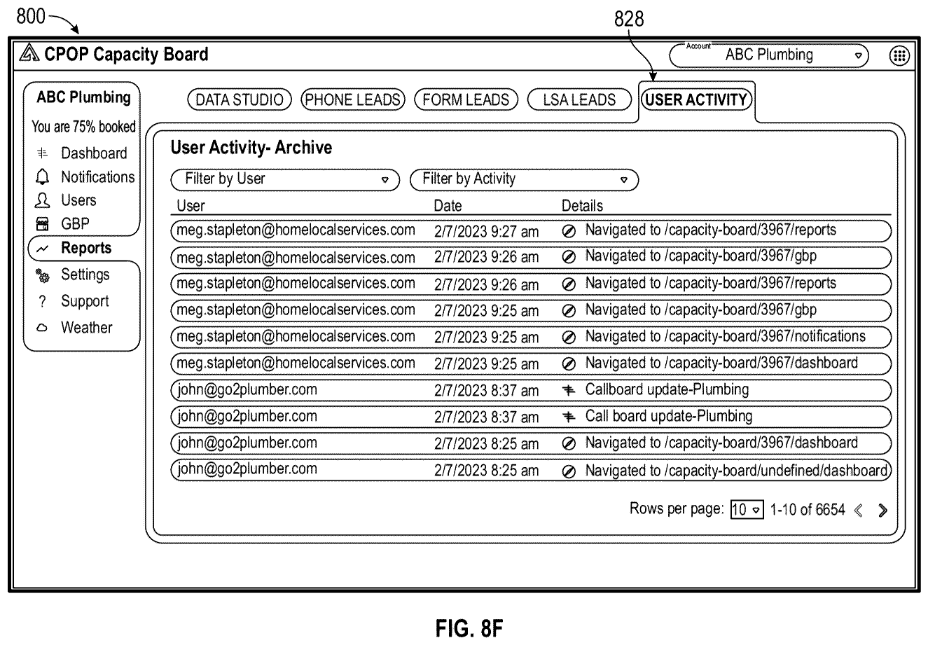

A user may select the transaction dashboard interface selector 448 to open the transaction dashboard interface 400, an example of which is shown in FIG. 4. The user may select the notifications interface selector 452 to open a notifications interface 900, an example of which is shown in FIG. 9. The user may select the authorized users interface selector 456 to open an authorized users interface 600, an example of which is shown in FIG. 6. The user may select the transaction verification interface selector 460 to open an transaction verification interface 700, an example of which is shown in FIGS. 7A-7C. The user may select the interaction report interface selector 464 to open an interaction report interface 800, an example of which is shown in FIGS. 8A-8E. Each of the interfaces may be configured to be opened immediately and/or automatically in response to the user selection. Additionally or alternatively the interfaces may be opened within a separate window and/or tab that may a user to operate within two or more interfaces simultaneously. This can allow a user to multitask among the interfaces. This kind of multitasking can be made possible by the unique configuration of the computing systems described herein.

The transaction dashboard interface 400 can include a transaction type descriptor 412, a transaction capacity segment indicator 414, and/or a remaining transaction capacity indicator 415. Transactions may be booked by other users as described herein. Capacity segments may be determined by a user. For example, a highest capacity segment may be between 0% and 50% booked. A middle capacity segment may be between about 50% and 80% booked. A lowest capacity segment may be between 80% and 100% booked. The transaction capacity segment indicator 414 in FIG. 4 shows that ABC Plumbing is currently at a level 3 capacity segment for the drain service. This corresponds to a 0% booked for drain service as shown in FIG. 4. The remaining transaction capacity indicator 415 shows how many more appointments can be filled before there is no more capacity for that kind of service. The service is indicated by the transaction type descriptor 412. In this case, the service is drain repair or replacement.

The transaction capacity interface 416 can include a current capacity segment indicator 420, a transaction data interface selector 424, a transaction capacity graphical selector 428, a transaction capacity selector 432, a remaining transaction capacity selector 436, a transaction capacity reset selector 440, and/or a save selector 444. The current capacity segment indicator 420 can reflect the same information as the transaction capacity segment indicator 414. The current capacity segment indicator 420 may indicate how many active segments (e.g., tiers) are available and/or which segment the service provider is in for the selected service.

The transaction data interface selector 424 can allow a user to review details of various of the transaction capacity segments. For example, user selection of the transaction data interface selector 424 can open a transaction data interface, such as the transaction data interface 500 shown in FIG. 5.

A user can use the transaction capacity graphical selector 428 to manually update a current capacity. The current capacity may apply to a particular day or time, such as Monday as shown in FIG. 4. The transaction capacity graphical selector 428 can include a dial, a slider, an in-graph selector (e.g., a window selector or box selector), a radio button, a spinner, and/or any other graphical selector. The transaction capacity graphical selector 428 can advantageously improve user engagement with the transaction dashboard interface 400 by allowing an intuitive user interface experience.

In some embodiments, the system can automatically update the current capacity. This update may be based on a separate user selection of reservation of transaction (e.g., via the client interface 300). The automatic update can be manually modified using the transaction capacity graphical selector 428, the transaction capacity selector 432, and/or remaining transaction capacity selector 436.

The transaction capacity selector 432 can allow a user to manually increase or decrease a target capacity, such as based on new reservations. Moving the transaction capacity selector 432 may automatically modify how the capacity segments are arranged. For example, the capacity segments may be determined based on regular or pre-set ratios or differences between segment endpoints. Modifying the capacity may change the total amount of capacity available for the particular transaction. Additionally or alternatively, the user may be able to modify the remaining transaction capacity selector 436 to increase or decrease the number of booked services. As noted above, the number of booked services may be automatically set based on a user's booking of the service (e.g., via the client interface 300). As shown in FIG. 4, the amount of “needed” bookings may be a difference between the capacity and the booked. The “needed” bookings may refer to how many more bookings are required to hit full capacity and/or to meet the next segment threshold.

A user may be able to reset the maximum or minimum available capacity and/or the maximum or minimum booked transactions using the transaction capacity reset selector 440. The user can save the settings and inputs using the save selector 444.

FIG. 5 shows an example transaction data interface 500, according to some embodiments. A user may initiate or open the transaction data interface 500 via the selector interface 408 in response to selecting the transaction data interface selector 424. The transaction data interface 500 can include a current transaction capacity segment indicator 516, one or more available transaction data selectors 504, a selected transaction data indicator 512, and/or a selected transaction data descriptor 516.

The transaction data interface 500 can be helpful to allow a user to see what available transactions have been created and what transaction details have been offered or displayed at a certain time. For example, a user may use the selected transaction data indicator 512 to select one of the available transaction data selectors 504. The selected transaction data indicator 512 can display the transaction details for the selected available transaction data selector 504. In some embodiments, the selected transaction data indicator 512 can indicate that the selected available transaction data corresponds to the current or “active” offer. The current or active offer can be the one that is displayed from or on a client interface, such as the client interface 300.

A user, such as a customer or potential customer, may contact a user of the transaction data interface 500. The contact may be via a message, such as via a message interface (e.g., the message interface 244). The contact may include a phone call, an email, a text message, and/or some other message. The message interface may record a time of receiving the contact. The time of the contact (e.g., the time the contact was first made) may indicate and/or correspond to particular transaction details that were displayed on a client interface (e.g., client interface 300) at that time. Thus, a user of the transaction data interface 500 may be able to determine what offer was provided to another user (e.g., customer) at a different time (e.g., earlier time).

The available transaction data selectors 504 may provide various transaction details corresponding to different transaction segments (e.g., tiers). The transaction segment of each available transaction data selector 504 may be indicated by a corresponding segment indicator 508. The segment indicator 508 may include an icon, such as a circular field with a number inside indicating the segment number. In some embodiments, a lower segment number corresponds to lower available transaction capacity (e.g., more booked transactions for lower transaction segment number). In some embodiments, a user can select target transaction details using the selected transaction data indicator 512 to update current or future transaction details and/or to update a transaction segment.

FIG. 6 shows an example authorized users interface 600, according to some embodiments. A user may reach the authorized users interface 600 via the selector interface 408 in response to selecting the authorized users interface selector 456. The authorized users interface 600 can allow a user to see who the authorized users of a user interface disclosed herein (e.g., the user interface 106, the transaction dashboard interface 400, the authorized users interface 600, etc.) are. The authorized users interface 600 can include one or more authorized user indicators 604 as shown. Each authorized user indicator 604 may indicate contact information, a last time of access of the user interface, a status of the user, and/or other information that may be useful. The system can use a firewall and/or security credentials to prevent unauthorized users from accessing the user interface. For example, a username, password, and/or independent authorization may be required. The independent authorization may include a 2-step verification process. The two-step authorization may include requiring a user to select a third-party selector, requiring a biometric verification (e.g., a fingerprint, retina verification, facial recognition), requiring a second password, and/or requiring another credential to further verify the authorized user's identity.

FIG. 7A shows an aspect of a transaction verification interface 700, according to some embodiments. The transaction verification interface 700 can be accessed by a user in response to user selection of the transaction verification interface selector 460 of the selector interface 408. The transaction verification interface 700 can include a review interface 704, which may be selectable as a tab or other selector near a top of the transaction verification interface 700. The review interface 704 can include one or more verified review indicators 708. The verified review indicators 708 confirm that transactions (e.g., services) have been successfully performed for other users. These users may have provided a review of and/or comment on the transaction received. Each verified review indicator 708 may indicate that review and/or comment. Additionally or alternatively, the verified review indicator 708 may include an indication of whether a user of the user interface (e.g., of the transaction verification interface 700) has replied to the other user. The verified review indicator 708 can include a rating and/or a date that the review and/or transaction was received.

In some embodiments, the displayed transaction data may be based at least in part on the verified nature of the transactions. For example, a transaction segment may not be adjusted until scheduled transaction can be verified by the system. The verification may include a user verification, an independent verification, a verification from a remote server (e.g., the remote computing device 140, the remote computing device 240), a verification from a data source (e.g., data source 136, data source 236), and/or verification from a client interface (e.g., client interface 144).

FIG. 7B shows another aspect of the example transaction verification interface 700 of FIG. 7A. The transaction verification interface 700 can include a reputation interface 712. The reputation interface 712 may be accessible via a reputation tab or other selector of the transaction verification interface 700. The reputation interface 712 can include a reputation history indicator 716. The reputation history indicator 716 may include a graphical indicator of how the reputation of the transactions offered by the associated service provider (e.g., ABC Plumbing). The graphical indicator can include a line chart, a graph, a bar chart, a scatterplot, a pie chart, an x-y plot, an arca chart, and/or some other graphical indicator. The graphical indicator can show a history of the verified transactions that have taken place (e.g., services provided).

FIG. 7C shows another aspect of the transaction verification interface 700 of FIG. 7A. The transaction verification interface 700 can include a transaction interaction interface 720. The transaction interaction interface 720 may be accessed by a user by selection of a “posts” tab or other selector. The transaction interaction interface 720 can include a transaction type selector interface 722, one or more transaction interaction indicators 724, and/or corresponding one or more interaction type indicators 728.

The transaction type selector interface 722 can include one or more transaction type selectors 723, such as an Add Covid Alert selector, an Add Event selector, an Add Offer selector, and/or an Add Post selector. Corresponding indicators may be displayed as interaction type indicators 728. A user may use the transaction type selector interface 722 to create a new publication, such as an announcement, a global offer, an event, and/or an alert. The list of these publications may be displayed as transaction interaction indicators 724. Each transaction interaction indicator 724 can include a corresponding publication and/or indicator.

In some embodiments, the transaction interaction indicators 724 and/or transaction type selectors 723 can influence the accessibility of certain transaction data described herein. For example, a certain kind of alert (e.g., a Covid alert) may prevent a user from scheduling a transaction service for a particular amount of time starting from a target time and/or date. In some embodiments, the user interface (e.g., the client interface 300) may prevent a user from scheduling a transaction due to a restriction (e.g., a restriction due to Covid) until the restriction is removed. Such removal may itself generate a separate alert or other publication.

FIG. 8A shows an example interaction report interface 800, according to some embodiments. The interaction report interface 800 can include a report overview 804, which may be accessed by selection of a corresponding selector (e.g., tab). The report overview 804 can include one or more interaction type indicators 808. The interaction type indicator 808 can indicate an amount of interactions and/or type of those interactions that have occurred within a certain time frame. For example, an interaction type indicator 808 may suggest that 1,001 total calls have been, 620 of which were paid calls and 381 of which were organic calls. Additionally or alternatively, an interaction type indicator 808 can indicate that a total of 130 chats occurred, of which 92 were paid chats and 38 of which were organic chats. FIG. 8A shows that 80 total forms were made, of which 58 were paid and 22 were organic.

The interaction graphical indicator 812 may additionally or alternatively include an interaction graphical indicator 812. The interaction graphical indicator 812 can show graphically what may be shown in part by the interaction type indicators 808. Other information, such as a proportion of an audience that was reached, a number of associated sessions, and/or a number of users (e.g., unique users) who interacted with the system during that time.

In some embodiments, the system can use the report overview 804 to automatically update a customer interface (e.g., the client interface 300). For example, in response to a threshold number of interactions of a certain type (e.g., total forms), the customer interface may automatically indicate to a potential customer that space is running out because the particular service in question is in high demand at this time. This feature requires a computational solution that involves many computing elements to interact in a unique and complicated way to provide a technical solution that results in an improved user experience (e.g., for the customer).

FIG. 8B shows another aspect of the interaction report interface 800 shown in FIG. 8A. The report overview 804 of the interaction report interface 800 can further include one or more interaction graphical indicators 812 as shown. The interaction graphical indicators 812 can include bar graphs, line graphs, pie charts, and/or any other graphical indicator described herein. These graphical indicators can provide a user additional information about a demand for certain transactions, a speed at which certain transactions are being booked, and/or other data that may influence how the system interacts and operates with a user.

For example, a user may use the report overview 804 to update one or more thresholds described herein. By way of illustration, the interaction report interface 800 may allow a user to update a threshold for when automatic alerts to a potential customer arise, a duration of such automatic alerts, and/or how soon after visiting a page the alerts may appear. A user of the interaction report interface 800 may want to specify, based on the information disclosed by the interaction graphical indicators 812, that an alert suggesting that the services provided may soon run out is to be displayed within 15 seconds of a potential customer's arrival opening of the user interface (e.g., the client interface 300). The user of the interaction report interface 800 may further specify that the alert should be displayed every 30 seconds and should last until dismissed. Other alternatives are possible.

FIG. 8C shows another aspect of the interaction report interface 800 shown in FIG. 8A. The interaction report interface 800 can include a phone interaction interface 816 that is selectable using a corresponding selector. The phone interaction interface 816 can display when (e.g., time, date) a phone call was made, for how long, a key word or summary of the call, a name of the caller, and/or other details. A user may reference this information when determining whether a particular transaction offer, such as having transaction details associated with a lower transaction segment, should be availed to a particular caller. As noted above, in some embodiments, the system can automatically identify when a caller contacted the system and/or what transaction details were active at the time of the call.

In some embodiments, a user of the interaction report interface 800 can select an indicator within the phone interaction interface 816 to see what transaction details were active at the time of the phone call. For example, a user may select the third phone call indicator in FIG. 8C and may automatically be transferred to a different user interface, such as the transaction data interface 500 of FIG. 5, to see which details were active at the time of the call, how soon the transaction details were changed to and/or from different transaction details from a different segment, and/or other relevant information (e.g., extenuating circumstances of the caller). Such details may be helpful for a user and/or the system in determining whether certain transaction details not currently “active” should be available to a potential customer.

FIG. 8D shows another aspect of the interaction report interface 800, according to some embodiments. The interaction report interface 800 can include an web form interaction interface 820. The web form interaction interface 820, like the phone interaction interface 816, can display information related to a contact from a verified customer. The information may include a type of service, a name of the customer, a message from the customer, and a date of the contact.

Such contacts can be used by the system to determine whether the transaction details need to be updated. The system may automatically update the transaction details based on information provided by a customer. For example, a client interface (e.g., the client interface 300) may update the transaction details (or suggest such updated transaction details to a user of the interface, such as the service provider) to display additional details (e.g., additional services offered) based on a customer specifying that a certain transaction did include or should include the additional details.

FIG. 8E shows another aspect of the interaction report interface 800 of FIG. 8A, according to some embodiments. The interaction report interface 800 can include a local service leads interface 824. The local service leads interface 824 can include one or more indications of contacts (e.g., phone contact, form contacts, other message contacts) that have come directly from advertisements or other content associated with the user interface. These leads may automatically cause the relevant transaction segment to be updated based on the lead and/or a nature of the lead. For example, a contact may cause a temporary scheduling or reservation to be made while the contact is able to be assessed (e.g., contacted by a user of the interaction report interface 800). If the contact cannot be confirmed, the temporary reservation may be removed, which may cause the transaction segment to be updated, such as reverting to a previous segment. Other alternatives are possible.

FIG. 8F shows another aspect of the interaction report interface 800 of FIG. 8A, according to some embodiments. The interaction report interface 800 can include a user activity interface 828 in response to user selection of a corresponding selector (e.g., “user activity” selector). The user activity interface 828 can include a record of actions a user (e.g., authorized user) has taken within the user interface. For example, the user activity interface 828 may track when an authorized user has navigated to certain tabs, updated transaction details, updated transaction thresholds, contacted a customer or other user via the interface, received a contact from a customer or other user, or taken other action described herein. In some embodiments, a user may be able to automatically reverse an action taken previously by a user. For example, a user may be able to cause transaction details to revert to a previous set of details in response to clicking a corresponding selector on the user activity interface 828. Additionally or alternatively, a user may be able to reconnect with a user (e.g., phone call, form message, other message) in response to user selection of a selector.

FIG. 9 shows an example notifications interface 900, according to some embodiments. A user may navigate to the notifications interface 900 via selection of the notifications interface selector 452 of FIG. 4. The notifications interface 900 can include one or more alerts or notifications 904. The notifications 904 may be listed alphabetically and/or chronologically. The notifications 904 may be automatically generated in response to actions described herein. For example, as shown, a notification 904 may be generated in response to a certain amount of transactions having been booked (e.g., ABC Plumbing is now 75% booked). Additionally or alternatively, a notification 904 can be generated in response to a service provider having achieved a certain transaction segment (e.g., “ABC Plumbing has reached the Tier 2 campaign”). The alert may additionally or alternatively include reference to the transaction details associated with the achieved transaction segment. A notification 904 may be automatically generated in response to an updated segment and/or segment transaction details. In some embodiments, a notification 904 is automatically generated in response to a modification of the segment threshold (e.g., “Tier 3 offers are now available starting at 80% booked).

The notification 904 can include an indication of an automatic adjustment of a resource output and/or a connecting parameter. For example, the automatic adjustment notification may indicate that a price and/or marketing outreach has been increased based on a lower than projected capacity for a present and/or future time. Additionally or alternatively, the automatic adjustment may relate to an increase in price or a increase in the offer based on a determination that a present capacity has dropped below a threshold described herein. Other notifications may be automatically generated in response to any other details described herein.

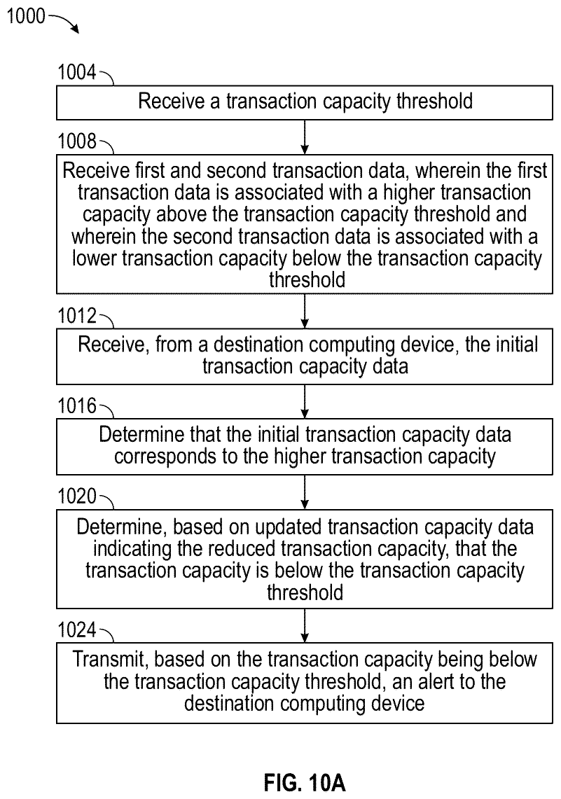

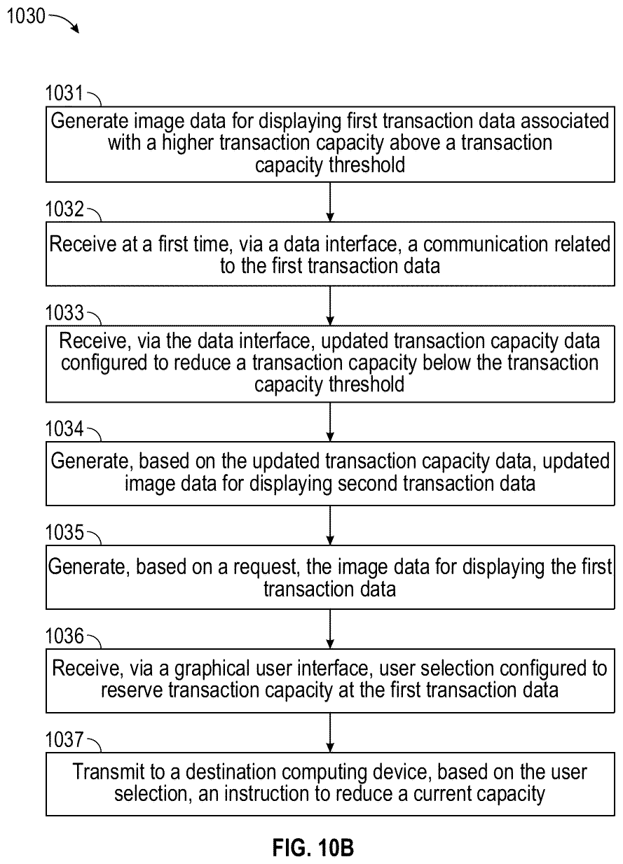

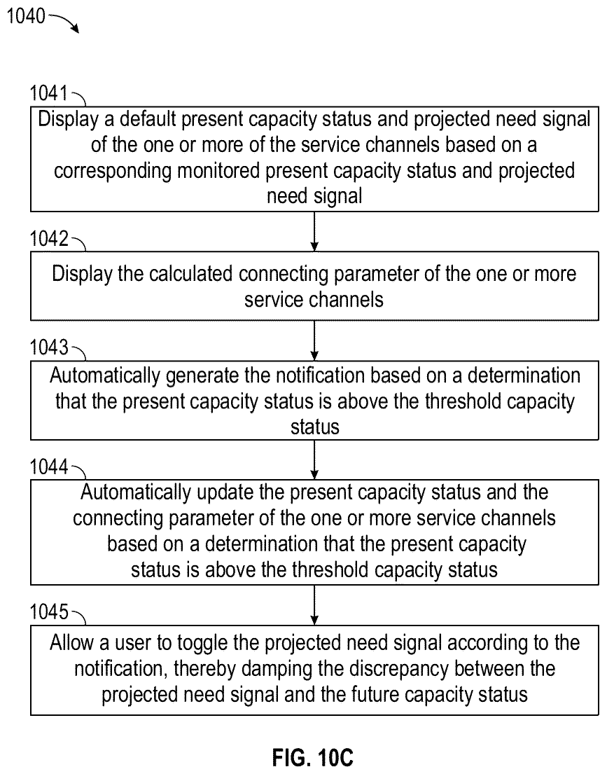

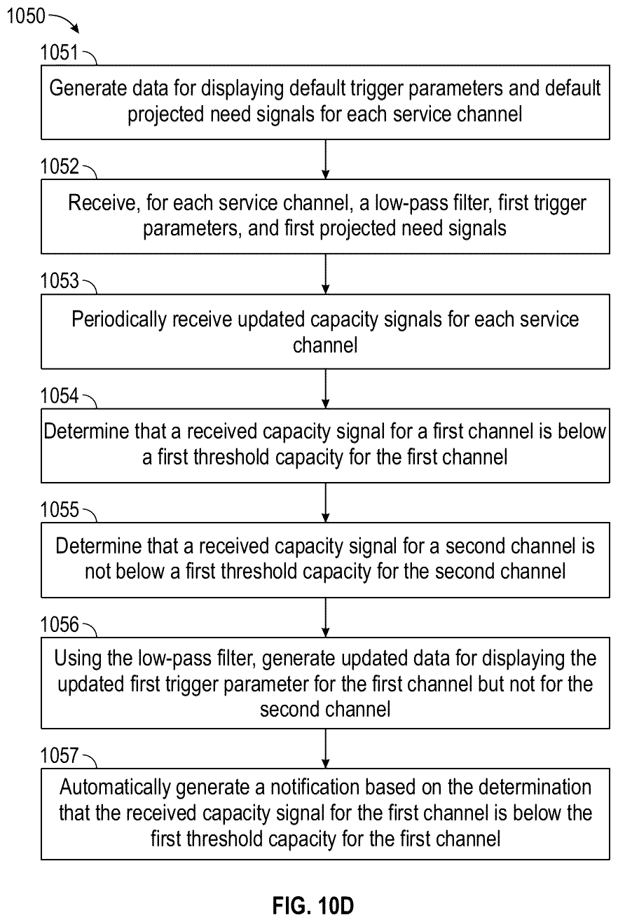

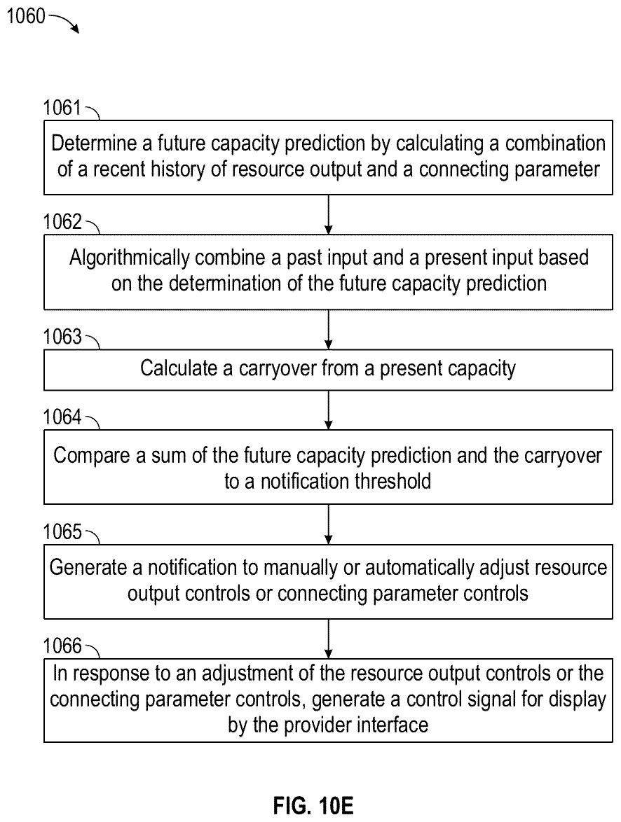

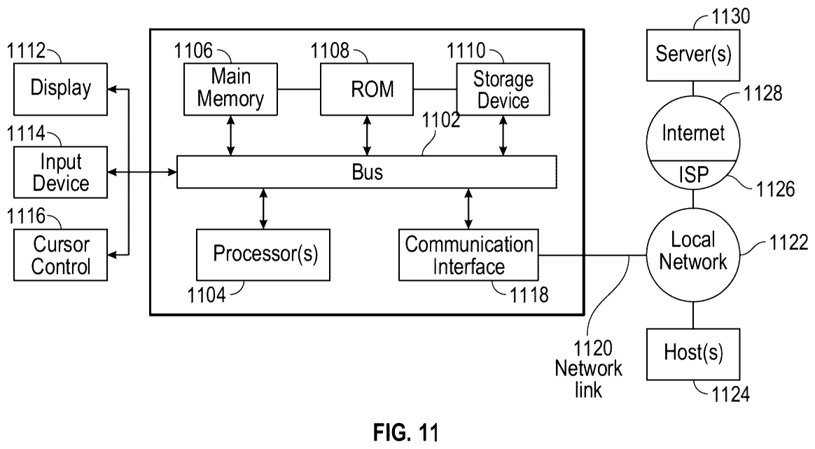

FIG. 10A shows an example method 1000, according to some embodiments. The method 1000 may be performed by a system described herein (e.g., capacity management system 100, signal filtering system 150, signal damping system 170, user prediction system 190, capacity management system 200). At block 1004, the system may receive a transaction capacity threshold. At block 1008, the system can receive first and second transaction data. The first transaction data may be associated with a higher transaction capacity above the transaction capacity threshold. Additionally or alternatively, the second transaction data may be associated with a lower transaction capacity below the transaction capacity threshold. At block 1012, the system may receive, from a destination computing device (e.g., the remote computing device 140, the client computing devices 164a, 164b, the remote computing devices 168a, 168b, the client computing devices 176a, 176b, 176c, the remote computing device 178), the initial transaction capacity data. At block 1016, the system may determine that the initial transaction capacity data corresponds to the higher transaction capacity. At block 1020, the system may determine, based on updated transaction capacity data indicating the reduced transaction capacity, that the transaction capacity is below the transaction capacity threshold. At 1024, the system may transmit, based on the determination that the transaction capacity being below the transaction capacity threshold, an alert to the destination computing device. The method 1000 may include other steps described elsewhere herein, such as by the systems described herein. Additionally or alternatively, the method 1000 may include fewer steps and/or perform them in a different order.

FIG. 10B shows another example method 1030, according to some embodiments. The method 1030 may be performed by any system described herein (e.g., capacity management system 100, signal filtering system 150, signal damping system 170, user prediction system 190, capacity management system 200). At block 1031, the system may generate image data for displaying first transaction data associated with a higher transaction capacity above a transaction capacity threshold. At block 1032, the system may receive at a first time, via a data interface, a communication related to the first transaction data. At block 1033, the system can receive, via the data interface, updated transaction capacity data configured to reduce a transaction capacity below the transaction capacity threshold. At block 1034, the system can generate, based on the updated transaction capacity data, updated image data for displaying second transaction data. At block 1035, the system can generate, based on a request, the image data for displaying the first transaction data. At block 1036, the system can receive, via a graphical user interface (e.g., the user interface 106, the user interface 156, the user interface 186, the provider interface 192, the user interface 198, the client interface 300, the transaction dashboard interface 400), user selection configured to reserve transaction capacity at the first transaction data. At block 1037, the system can transmit to a destination computing device (e.g., the remote computing device 140, the client computing devices 164a, 164b, the remote computing devices 168a, 168b, the client computing devices 176a, 176b, 176c, the remote computing device 178), based on the user selection, an instruction to reduce a current capacity. The instruction may be for a manual and/or automatic reduction in current capacity. The method 1030 may include other steps described elsewhere herein, such as by the systems described herein. Additionally or alternatively, the method 1030 may include fewer steps and/or perform them in a different order.

FIG. 10C shows another example method 1040, according to some embodiments. The method 1040 may be performed by any system described herein (e.g., capacity management system 100, signal filtering system 150, signal damping system 170, user prediction system 190, capacity management system 200). At block 1041, the system may display a default present capacity status and projected need signal of the one or more of the service channels based on a corresponding monitored present capacity status and projected need signal. At block 1042, the system may display the calculated connecting parameter of the one or more service channels. At block 1043, the system can automatically generate the notification based on a determination that the present capacity status is above the threshold capacity status. At block 1044, the system can automatically update the present capacity status and the connecting parameter of the one or more service channels based on a determination that the present capacity status is above the threshold capacity status. At block 1045, the system can allow a user to toggle the projected need signal according to the notification, thereby damping the discrepancy between the projected need signal and the future capacity status. The method 1040 may include other steps described elsewhere herein, such as by the systems described herein. Additionally or alternatively, the method 1040 may include fewer steps and/or perform them in a different order.

FIG. 10D shows another example method 1050, according to some embodiments. The method 1050 may be performed by any system described herein (e.g., capacity management system 100, signal filtering system 150, signal damping system 170, user prediction system 190, capacity management system 200). At block 1051, the system may generate data for displaying default trigger parameters and default projected need signals for each service channel. At block 1052, the system may receive, for each service channel, a low-pass filter, first trigger parameters, and first projected need signals. At block 1053, the system can periodically receive updated capacity signals for each service channel. At block 1054, the system can determine that a received capacity signal for a first channel is below a first threshold capacity for the first channel. At block 1055, the system can determine that a received capacity signal for a second channel is not below a first threshold capacity for the second channel. At block 1056, the system can use the low-pass filter to generate updated data for displaying the updated first trigger parameter for the first channel but not for the second channel. At block 1057, the system can automatically generate a notification based on the determination that the received capacity signal for the first channel is below the first threshold capacity for the first channel. The method 1050 may include other steps described elsewhere herein, such as by the systems described herein. Additionally or alternatively, the method 1050 may include fewer steps and/or perform them in a different order.

FIG. 10E shows another example method 1060, according to some embodiments. The method 1060 may be performed by any system described herein (e.g., capacity management system 100, signal filtering system 150, signal damping system 170, user prediction system 190, capacity management system 200). At block 1061, the system may determine a future capacity prediction by calculating a combination of a recent history of resource output and a connecting parameter. At block 1062, the system may algorithmically combine a past input and a present input based on the determination of the future capacity prediction. At block 1063, the system can calculate a carryover from a present capacity. At block 1064, the system can compare a sum of the future capacity prediction and the carryover to a notification threshold. At block 1065, the system can generate a notification to manually or automatically adjust resource output controls or connecting parameter controls. At block 1066, the system can generate a control signal for display by the provider interface in response to an adjustment of the resource output controls or the connecting parameter controls. The method 1060 may include other steps described elsewhere herein, such as by the systems described herein. Additionally or alternatively, the method 1060 may include fewer steps and/or perform them in a different order.

### Example Embodiments

Some example embodiments are provided below for illustration purposes. Additional or alternative examples are possible.

In a 1st Example, a computing system comprises: a computer readable storage medium having program instructions embodied therewith; a data interface configured to receive an initial transaction capacity data and an updated transaction capacity data; and one or more processors configured to execute the program instructions to cause the computing system to: receive, via an interactive graphical user interface, a transaction capacity threshold; receive, via the interactive graphical user interface, first and second transaction data, wherein the first transaction data is associated with a higher transaction capacity above the transaction capacity threshold and wherein the second transaction data is associated with a lower transaction capacity below the transaction capacity threshold; receive, from a destination computing device via a data interface, the initial transaction capacity data; determine that the initial transaction capacity data corresponds to the higher transaction capacity; generate, based on the determination that the initial transaction capacity corresponds to the higher transaction capacity, image data for displaying the first transaction data; receive, from the destination computing device via the data interface, the updated transaction capacity data, the updated transaction capacity data indicating a reduced transaction capacity; determine, based on the updated transaction capacity data indicating the reduced transaction capacity, that the transaction capacity is below the transaction capacity threshold; generate, based on the updated transaction capacity data indicating the reduced transaction capacity, updated image data for displaying the second transaction data; receive, from the destination computing device, a request for a current transaction capacity or for current transaction data; and transmit, based on the transaction capacity being below the transaction capacity threshold and in response to the request, an alert to the destination computing device, the alert comprising the second transaction data and an indication of the current transaction capacity.

In a 2nd example, the system of Example 1, wherein the one or more processors are configured to execute the program instructions to cause the computing system to: receive, via the interactive graphical user interface, third transaction data, wherein the third transaction data is associated with a limited transaction capacity below a second transaction capacity threshold below the transaction capacity threshold; receive, via the data interface, an additional transaction reservation, the additional transaction reservation further reducing the transaction capacity; determine, based on the additional transaction reservation further reducing the transaction capacity, that the transaction capacity is below the second transaction capacity threshold; transmit, based on the transaction capacity being below the second transaction capacity threshold, updated image data for displaying the third transaction data; and transmit, based on the transaction capacity being below the transaction capacity threshold, a second alert to the destination computing device, the second alert comprising the third transaction data and a second indication of the current transaction capacity.

In a 3rd Example, the system of Example 2, wherein the one or more processors are configured to execute the program instructions to cause the computing system to: receive, from the destination computing device, a second request for the current transaction capacity or for current transaction data, wherein transmitting the second alert to the destination computing device is further in response to the second request.

In a 4th Example, the system of any of Examples 1-3, wherein the alert comprises an email.

In a 5th Example, the system of any of Examples 1-4, wherein the alert comprises a message accessible via the interactive graphical user interface.

In a 6th Example, the system of any of Examples 1-5, wherein receiving the initial transaction capacity comprises downloading pending or completed transaction data.

In a 7th Example, the system of Example 6, wherein downloading the pending or completed transaction data is downloaded from the destination computing device.

In an 8th Example, the system of any of Examples 6-7, wherein downloading the pending or completed transaction data comprises receiving an email to the destination computing device.

In a 9th Example, a computing system comprising: a computer readable storage medium having program instructions embodied therewith; a data interface configured to receive updated transaction capacity data; and one or more processors configured to execute the program instructions to cause the computing system to: receive, via an interactive graphical user interface, a transaction capacity threshold; receive, via the interactive graphical user interface, first and second transaction data, wherein the first transaction data is associated with a higher transaction capacity above the transaction capacity threshold and wherein the second transaction data is associated with a lower transaction capacity below the transaction capacity threshold; generate, based on the higher transaction capacity, image data for displaying the first transaction data; receive, via a data interface, the updated transaction capacity data, the updated transaction capacity data reducing the transaction capacity; determine, based on the updated transaction capacity data reducing the transaction capacity, that the transaction capacity is below the transaction capacity threshold; generate, based on the updated transaction capacity data reducing the transaction capacity, updated image data for displaying the second transaction data; and transmit, based on the transaction capacity being below the transaction capacity threshold, an alert to a remote computing device, the alert comprising the second transaction data and an indication of the current transaction capacity.

In a 10th Example, the system of Example 9, wherein the one or more processors are configured to execute the program instructions to cause the computing system to: receive, via the interactive graphical user interface, third transaction data, wherein the third transaction data is associated with a limited transaction capacity below a second transaction capacity threshold below the transaction capacity threshold; receive, via the data interface, an additional transaction reservation, the additional transaction reservation further reducing the transaction capacity; determine, based on the additional transaction reservation further reducing the transaction capacity, that the transaction capacity is below the second transaction capacity threshold; transmit, based on the transaction capacity being below the second transaction capacity threshold, updated image data for displaying the third transaction data; and transmit, based on the transaction capacity being below the transaction capacity threshold, a second alert to the remote computing device, the second alert comprising the third transaction data and a second indication of the current transaction capacity.

In a 11th Example, the system of Example 10, wherein the one or more processors are configured to execute the program instructions to cause the computing system to: receive, from a destination computing device, a request for a current transaction capacity or for current transaction data, wherein transmitting the alert to the remote computing device is in response to the request.

In a 12th Example, the system of any of Examples 9-11, wherein the alert comprises an email or a text message.

In a 13th Example, the system of any of Examples 9-12, wherein the alert comprises a message accessible via the interactive graphical user interface.

In a 14th Example, a computing system comprising: a computer readable storage medium having program instructions embodied therewith; a data interface configured to receive updated transaction capacity data; and one or more processors configured to execute the program instructions to cause the computing system to: generate image data for displaying first transaction data associated with a higher transaction capacity above a transaction capacity threshold, wherein the first transaction data is associated with a higher transaction capacity above the transaction capacity threshold; receive at a first time, via a data interface, a communication related to the first transaction data; receive, via the data interface, updated transaction capacity data, the updated transaction capacity data reducing the transaction capacity below the transaction capacity threshold; generate, based on the updated transaction capacity data reducing the transaction capacity, updated image data for displaying second transaction data, wherein the second transaction data is associated with a lower transaction capacity below the transaction capacity threshold; receive a request to update a display based on the first time; generate, based on the request, the image data for displaying the first transaction data; receive, via the graphical user interface, user selection configured to reserve transaction capacity at the first transaction data; transmit to the destination computing device, based on the user selection, an instruction to reduce a current capacity.

In a 15th Example, the system of Example 14, wherein the one or more processors are configured to execute the program instructions to cause the computing system to: initiate, via the graphical user interface, an audio communication with a user who generated the communication related to the first transaction data.

In a 16th Example, the system of any of Examples 14-15, wherein the alert comprises an email.

In a 17th Example, the system of any of Examples 14-16, wherein the alert comprises a message accessible via the interactive graphical user interface.

In a 18th Example, the system of any of Examples 14-17, wherein receiving the current transaction capacity comprises downloading pending or completed transaction data.

In a 19th Example, the system of any of Examples 14-18, wherein downloading the pending or completed transaction data is downloaded from the destination computing device.

In a 20th Example, the system of any of Examples 14-17, wherein the communication comprises a phone call.

In a 21st Example, a damping system for capacity signals using a connecting parameter, the system comprising: a processor and memory configured to reduce a projected need status by generating a notification; and a capacity status server configured to monitor a present capacity status of first and second service channels, each service channel configurable to be throttled based on whether a present capacity status is above a threshold capacity status; the processor and memory further configured to periodically monitor each of the following for each of the first and second service channels: a present capacity status; a projected need signal; and a connecting parameter, based on a calculation using the present capacity status and projected need signal of the corresponding service channel; the processor and memory further configured to reduce a lag time between the present capacity status and the projected need signal of each service channel, thereby damping a discrepancy between the projected need signal and a future capacity status, both for the same given future time, for one or more of the service channels; the processor and memory further configured to generate a user interface configured to: display a default present capacity status and projected need signal of the one or more of the service channels based on the corresponding monitored present capacity status and projected need signal; display the calculated connecting parameter of the one or more service channels; automatically generate the notification based on a determination that the present capacity status is above the threshold capacity status, the notification comprising a present capacity status of one or more services of at least one service channel; automatically update the present capacity status and the connecting parameter of the one or more service channels based on the determination that the present capacity status is above the threshold capacity status; and allow a user to toggle the projected need signal according to the notification, thereby damping the discrepancy between the projected need signal and the future capacity status.

In a 22nd Example, the damping system of Example 21, wherein the notification comprises an indication of the updated present capacity status or projected need signal.

In a 23rd Example, the damping system of any of Examples 21-22, wherein automatically updating the present capacity status and the connecting parameter of the one or more service channels comprises reducing the present capacity and increasing the connecting parameter according to a stepwise function.

In a 24th Example, a signal filtering system for applying a low-pass filter based on updated capacity signals, the system comprising: a data interface configured to receive capacity signals; a processor and memory comprising instructions thereon, the processor configured to execute the instructions to: generate data for displaying default trigger parameters and default projected need signals for each of the first and second service channels; receive, via a user interface, for each of first and second service channels: a low-pass filter comprising first threshold capacities; first trigger parameters stronger than the default trigger parameters; and first projected need signals weaker than the default projected need signals; periodically receive, from an electronic device via the data interface, the updated capacity signals for each of the first and second service channels; determine that a received capacity signal for the first channel is below the first threshold capacity for the first channel; determine that a received capacity signal for the second channel is not below the first threshold capacity for the second channel; using the low-pass filter, generate updated data for displaying the updated first trigger parameter for the first channel but not for the second channel based on the determination that the received capacity signal for the first channel is below the first threshold capacity for the first channel but that the received capacity signal for the second channel is not below the first threshold capacity for the second channel; and automatically generate a notification based on the determination that the received capacity signal for the first channel is below the first threshold capacity for the first channel, the notification comprising a display of the first projected need signal.

In a 25th Example, the signal filtering system of Example 24, wherein the notification further comprises a display of the first trigger parameter.

In a 26th Example, a system for predicting user response and real-time interaction with automated provider notifications, the system comprising: a provider interface comprising: a capacity input control; a resource output control; a connecting parameter control; an analysis module comprising: a notification generator configured to accept input from the capacity input control, resource output control, and connecting parameter control; and a records monitor configured to store a record of the input accepted by the notification generator, wherein the analysis module is configured to: determine a future capacity prediction by calculating a combination of a recent history of resource output and a connecting parameter, modified by efficiency and delay functions; algorithmically combine a past input and a present input based on the determination of the future capacity prediction; calculate a carryover from a present capacity; compare a sum of the future capacity prediction and the carryover to a notification threshold; determine that the sum exceeds the notification threshold; generate a notification to manually or automatically adjust one or more of the resource output controls or the connecting parameter controls; and in response to an adjustment of the one or more of the resource output controls or the connecting parameter controls, generate a control signal for display by the provider interface.

In a 27th Example, the system of Example 26, further comprising a user interface comprising: a resource output display configured to promptly respond to control signals from the analysis module such that it changes output to user in real time in response to provider updates; a connecting parameter display configured to promptly respond to control signals from the analysis module such that it changes output to user in real time to provider updates; and a response control configured to change future provider capacity based on present connecting parameter value.

In a 28th Example, the system of Example 27, further comprising a feedback system configured to determine an effectiveness of the analysis module in determining the future capacity prediction.

In a 29th Example, the system of Example 28, wherein determining the effectiveness of the analysis module in determining the future capacity prediction comprises: determining whether a history of sums comprising the sum includes a number of times alerts were generated; and determining whether the number of times alerts were generated exceeds a satisfaction threshold.

In a 30th Example, the system of Example 29, wherein the feedback system is configured, in response to determining that the history of sums comprises the number of times alerts were generated exceeds the satisfaction threshold, to reduce or increase the future capacity prediction in a future calculation.

In a 31th Example, the system of any of Examples 27-30, wherein the analysis module is configured to automatically increase the connecting parameter when the sum of the future capacity prediction and the carryover exceeds the notification threshold.

In a 32th Example, the system of any of Examples 27-31, wherein the records monitor is configured to store a relationship between the resource output control and the connecting parameter.

In a 33th Example, the system of Example 32, wherein the relationship comprises a step function such that the relationship corresponds to different levels of connecting parameter and/or resource output to achieve local minima of future capacity.

In a 34th Example, the system of any of Examples 27-33, wherein the analysis module is configured to damp fluctuations in future provider capacity by using the efficiency and delay functions to predict user use of response control and preempting changes by notifying user to reduce resource output control and increase connecting parameter control.

In a 35th Example, the system of any of Examples 27-34, wherein the notification includes at least one paired suggestion for size of incremental change to both resource output and connecting parameter, based on feedback from previous use.

In a 36th Example, the system of any of Examples 27-35, wherein the capacity input control comprises water in a reservoir, the resource output channel comprises a number of recipients or channels providing capacity information to one or more third parties, and the connecting parameter comprises at least one of credits, price, coupons, or offers for obtaining water.

In a 37th Example, the system of any of Examples 27-36, wherein the capacity input control comprises unfilled time slots for workers, the resource output channel comprises a digital marketing budget for reaching third parties, and the connecting parameter comprises at least one of credits, price, coupons, or offers for obtaining services provided by the workers.

### Additional Implementation Details

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an crasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the “C” programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 11 is a block diagram that illustrates a computer system 1100 upon which various embodiments may be implemented. For example, the computer system 1100 may be implemented as the capacity management system 100 (FIG. 1) in some embodiments. Computer system 1100 includes a bus 1102 or other communication mechanism for communicating information, and a hardware processor, or multiple processors, 1104 coupled with bus 1102 for processing information. Hardware processor(s) 1104 may be, for example, one or more general purpose microprocessors.

Computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk, optical disk, or USB thumb drive (Flash drive), etc., is provided and coupled to bus 1102 for storing information and instructions.

Computer system 1100 may be coupled via bus 1102 to a display 1112, such as a cathode ray tube (CRT) or LCD display (or touch screen), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

Computing system 1100 may include a user interface module to implement a GUI that may be stored in a mass storage device as computer executable program instructions that are executed by the computing device(s). Computer system 1100 may further, as described below, implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor(s) 1104 executing one or more sequences of one or more computer readable program instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative embodiments, hard-wired circuitry may be used in place of or in combination with software instructions.

Various forms of computer readable storage media may be involved in carrying one or more sequences of one or more computer readable program instructions to processor 1104 for execution. For example, the instructions may initially be carried on a magnetic disk or solid state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN (or WAN component to communicated with a WAN). Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

1. A damping system for capacity signals using a connecting parameter, the system comprising:
a processor and memory configured to reduce a projected need status by generating a notification; and
a capacity status server configured to store and monitor a present capacity status of first and second service channels, each service channel configurable to be throttled based on whether a present capacity status is above a threshold capacity status,
wherein the processor and memory are further configured to periodically receive, over a communication network, monitor, and store data for each of the following for each of the first and second service channels:
a present capacity status,
a projected need signal, and
a connecting parameter, based on a calculation using the present capacity status and projected need signal of the corresponding service channel,
the processor and memory further configured to:
use the stored data to predict a future capacity by calculating a combination of recent history of the projected need signal and recent history of the corresponding connecting parameters, modified by efficiency and delay functions;
algorithmically combine past and present capacity status data to determine if actual present capacity is greater than zero and if not, calculate a carryover amount and add it to the predicted future capacity to create a future capacity sum;
track and reduce a lag time between the present capacity status and the projected need signal of each service channel, thereby damping a discrepancy between the projected need signal and a future capacity sum, both for the same given future time, for one or more of the service channels, by:
generating data for displaying a default present capacity status and projected need signal of the one or more of the service channels based on the corresponding monitored present capacity status and projected need signal;
evaluating, at the capacity status server, a particular capacity segment corresponding to the connecting parameter, based on the present capacity status and the projected need signal;
generating updated data for displaying the calculated connecting parameter of the one or more service channels;
comparing the present capacity status or the future capacity sum to the threshold capacity status to determine that the present capacity status or the future capacity sum is above the threshold capacity status;
automatically generating, at the capacity status server, notification data based on the determination that the present capacity status or the future capacity sum is above the threshold capacity status, the notification data comprising:
a present capacity status of one or more services of at least one service channel; and
the particular capacity segment corresponding to the connecting parameter;
transmitting, over the communication network, the notification data to a remote computing device, the notification data configured to cause display of the notification at the remote computing device;
automatically updating the present capacity status and the connecting parameter of the one or more service channels based on the determination that the present capacity status is above the threshold capacity status;
transmitting to the remote computing device, over the communication network, first data indicative of the present capacity status and the connecting parameter of the one or more service channels;
capturing a user toggle of the projected need signal or connecting parameter controls, thereby damping the discrepancy between the projected need signal and the future capacity status; and
transmitting, over the communication network, second data indicative of an effect of the damped discrepancy to a plurality of remote client interfaces for display by corresponding user interfaces.

2. The damping system of claim 1, wherein the notification comprises an indication of the updated present capacity status or projected need signal.

3. The damping system of claim 1, wherein automatically updating the present capacity status and the connecting parameter of the one or more service channels comprises reducing the present capacity and increasing the connecting parameter according to a stepwise function.

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. The system of claim 1, wherein damping the discrepancy between the projected need signal and the future capacity sum comprises:
generating the second data indicative of the effect of the damped discrepancy,
wherein generating the second data comprises altering a web-based advertisement, and
wherein a remote client interface of the plurality of remote client interfaces corresponds to an Internet page accessed via a web browser.

27. The system of claim 1, wherein damping the discrepancy between the projected need signal and the future capacity sum comprises:
automatically adjusting a resource output control corresponding to a digital marketing parameter associated with a web-based advertisement, wherein automatically adjusting the digital marketing parameter changes at least one of a cost-per-click (CPC) or an impression.

28. The system of claim 1, wherein damping the discrepancy between the projected need signal and the future capacity sum comprises:
automatically adjusting a capacity input control based on amount of water in a reservoir and displaying capacity using a provider interface;
using the provider interface to adjust a resource output control and thereby change resources spent to reach potential water users; and
displaying a control signal using the provider interface to indicate a change to one or more of water capacity and resources for reaching potential water users.

29. The system of claim 28, wherein the efficiency function accounts for how much resource output is required per unit to achieve a request for one or more units of water delivery.

30. The system of claim 28, wherein the delay function accounts for how much time elapses, on average, between a given increase in resource output and a resulting request for one or more units of water delivery.

31. The system of claim 28, wherein the provider interface comprises a prediction of how much time will elapse before a new order of water arrives at an end user location.

32. A method for damping capacity signals using a connecting parameter, the method comprising:
storing and monitoring a present capacity status of first and second service channels;
throttling each service channel based on whether a present capacity status is above a threshold capacity status;
periodically receiving, over a communication network, and storing data for each of the following for each of the first and second service channels:
a present capacity status,
a projected need signal, and
a connecting parameter, based on a calculation using the present capacity status and projected need signal of the corresponding service channel;
predicting, based on the stored data, a future capacity by calculating a combination of recent history of the projected need signal and recent history of the corresponding connecting parameters, modified by efficiency and delay functions;
algorithmically combining past and present capacity status data to determine if actual present capacity is greater than zero and if not, calculating a carryover amount and adding it to the predicted future capacity to create a future capacity sum;
reducing a lag time between the present capacity status and the projected need signal of each service channel, thereby damping a discrepancy between the projected need signal and a future capacity sum, both for the same given future time, for one or more of the service channels, wherein reducing the lag time comprises:
generating data for displaying a default present capacity status and projected need signal of the one or more of the service channels based on the corresponding monitored present capacity status and projected need signal;
evaluating, at a capacity status server, a particular capacity segment corresponding to the connecting parameter, based on the present capacity status and the projected need signal;
generating updated data for displaying the calculated connecting parameter of the one or more service channels;
comparing the present capacity status or the future capacity sum to the threshold capacity status to determine that the present capacity status or the future capacity sum is above the threshold capacity status;
automatically generating, at the capacity status server, notification data based on the determination that the present capacity status or the future capacity sum is above the threshold capacity status, the notification data comprising:
a present capacity status of one or more services of at least one service channel; and
the particular capacity segment corresponding to the connecting parameter;
transmitting, over the communication network, the notification data to a remote computing device, the notification data configured to cause display of the notification at the remote computing device;
automatically updating the present capacity status and the connecting parameter of the one or more service channels based on the determination that the present capacity status is above the threshold capacity status;
transmitting to the remote computing device, over the communication network, first data indicative of the present capacity status and the connecting parameter of the one or more service channels;
capturing a user toggle of the projected need signal or connecting parameter controls, thereby damping the discrepancy between the projected need signal and the future capacity status; and
transmitting, over the communication network, second data indicative of an effect of the damped discrepancy to a plurality of remote client interfaces for display by corresponding user interfaces.
